(19) United States
(12) Patent Application Publication
(10) Pub. No.: US 2004/0109440 A1
(43) Pub. Date: Jun. 10, 2004

(54) OPTIMIZED PACKET AND TIME DIVISION MULTIPLEX TRANSMISSION AND NETWORK INTEGRATION

(76) Inventor: George P. Mattathil, San Bruno, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 10/605,958

(22) Filed: Nov. 10, 2003

Related U.S. Application Data
(63) Continuation-in-part of application No. 09/622,252, filed on Jan. 4, 2002, now Pat. No. 6,674,749.
Application No. 09/622,252 is a 371 of international application No. PCT/US00/01039, filed on Jan. 14, 2000.
(60) Provisional application No. 60/116,008, filed on Jan. 15, 1999.

(51) Int. Cl. H04L 12/66

(52) U.S. Cl. 370/352

(57) ABSTRACT

A bandwidth transfer switching system constructed of access concentrators, remote concentrators, relay nodes and at least one transfer switch. The access concentrators accept signals from various customer communications devices using switched signals and packet signals, including local area networks. The remote concentrators are optional, to group signals from multiple access concentrators. The relay nodes are also optional, to provided to increase signal distance. The transfer switch or switches receive the signals and route them onward to other customer devices located elsewhere. The transfer switches are located in a telco central office, or may be part of a private network constructed of access concentrators, remote concentrators, relay nodes and at least one transfer switch, or may be in a combination wherein a private network connects to a telco local loop.

### CROSS REFERENCE TO RELATED APPLICATIONS

This is a continuation-in-part of application Ser. No. 09/622,252, filed Jan. 4, 2002, which is a national phase of International Application No. PCT/US00/01039, filed Jan. 14, 2000, which claims the benefit of U.S. Provisional Application No. 60/116,008, filed Jan. 15, 1999.

### BACKGROUND OF INVENTION

1. Technical Field

The present invention relates generally to telecommunications, and more particularly to network communications over and bypassing public telephone switching systems.

2. Background Art

FIG. 1 (background art) is a block diagram depicting the existing infrastructure 10 of the public switched telephone network (PSTN). Various devices may communicate via the existing infrastructure 10, and users today often have and use multiple such devices. In FIG. 1 a telephone 12a, facsimile 12b, modem 12c, computer 12d, and special service device 12e are shown connected to a PSTN 14 and another telephone 12a, facsimile 12b, modem 12c, computer 12d, and special service device 12e are shown also connected to the PSTN 14. The telephones 12a and facsimiles 12b are analog type devices which may communicate with respective like devices. In FIG. 1 the modems 12c stylistically depict the still common situation of digital devices (not shown) producing digital signals that are converted to and from analog type signals, but otherwise communicating using analog techniques.

In contrast, the computers 12d and special service devices 12e shown here stylistically depict true digital type devices.

While the presence of computers 12d in the existing infrastructure 10 is relatively well known, some readers may not be familiar with the special service devices 12e. These are relatively common today, but little appreciated. Some examples include remote monitor able utility meters and alarm systems. Such special service devices 12e typically require a much lower data transfer rate than systems like the computers 12d.

For communications between the respective sets of like devices, the analog “traffic” may be entirely via the PSTN 14. In contrast, the digital traffic for the computers 12d may start on the PSTN 14 and then proceed via an Internet protocol network (IP network 18). Similarly, the digital traffic for the special service device 12e may start on the PSTN 14 and then proceed via a signal switching network, like the SS7 network 20 shown.

FIG. 2 (background art) is a block diagram depicting the most common digital, or “Internet call,” connection methodology. Digital devices (not shown here) produce digital signals which the modems 12c convert to analog type signals. The modems 12c connect to ingress switches 22 via conventional voice circuits or (commonly) plain old telephone service lines (POTS lines 24). The ingress switches 22 may connect directly to an egress switch 26, via POTS lines 24, or to a tandem switch 28 that further connects to the egress switch 26 via an interoffice trunk 30. The egress switch 26 is connected to an Internet service provider point-of-presence (ISP POP 32) via POTS lines 24. Often the ISPs will have multiple POTS lines 24 or ISDN primary rate interface configured into hunt groups, and this is the case depicted in FIG. 2. Finally, the ISP POP 32 connects to the IP network 18. Of course, digital communications going the other direction travel essentially the reverse path.

FIG. 3 (prior art) is a block diagram depicting the presently popular network evolution model, wherein the IP network 18 evolves to become a single common packet backbone. Analog devices like telephones 12a and facsimiles 12b (FIG. 1) have their signals converted to digital data packets. The same can be done for the analog output of modems 12c (FIG. 1), but would generally be pointless. Existing digital devices like the computers 12d would continue to connect to the IP network 18, and the special service devices 12e would evolve into types that could also connect to the IP network 18. New digital audio-video devices, like digital voice phones 12f and video units 12g (e.g., cameras, or “CAMs” as they are often termed in the industry) can similarly connect directly to the IP network 18. Unfortunately, there are problems with this evolution model. In particular, and as discussed more extensively elsewhere herein, it obsoletes the current investment in PSTN technology and it introduces a number of transitional technical problems.

FIG. 4 is a block diagram depicting a more suitable network evolution model. The various communications devices (12a-g) connect to an access network 34, and the access network 34 connects to the PSTN 14 (essentially the major central element already in the existing infrastructure 10), the IP network 18, the SS7 network 20 and also a broadband network 36. The IP network 18 can handle most existing bandwidth digital communications, and the broadband network 36 can handle high bandwidth communications such as digital video. Under this alternate network evolution model the broadband network 36 would initially be optional, and only added as needed.

FIG. 5 (background art) is a block diagram of a conventional current digital loop carrier communications architecture (DLC architecture 40). At a customer premises 42 a LAN 44 includes network devices 46 and what will here be termed customer premises equipment (CPE 48; such as a channel service unit/data service unit, analog/ISDN/xDSL type modems etc.). The customer premises 42 may also include plain old telephone service (POTS) devices, such as the telephone 12a which is shown.

The next segment in the communications architecture is the local loop 50. It primarily includes a remote terminal 52. Connecting digital traffic from the CPE 48 to the remote terminal 52 is one or more T1/E1/DSx lines 54 (which here may generically include all digital “copper wire” protocols as well, e.g., xDSL and ISDN). Carrying analog (e.g., voice, facsimile, and modem) POTS traffic to the remote terminal 52 are one or more POTS lines 24. A plurality of such customer premises 42 is typically serviced by each remote terminal 52.

Following this in the communications architecture is the central office 56, which includes a central office terminal 58 that connects to a central office switch 60 (larger central offices typically include multiple central office terminals 58 and multiple central office switches 60, and central offices may even have remote terminals 52 directly connected into the central office switches 60). Optionally, Internet routers 62 from Internet service providers (ISP's), may also be connected to the central office switch 60.

For simplicity in discussion, the Internet is used as a generic example of a specialized application network here, but it should be appreciated that many other examples exist. Alarm systems and video conferencing networks are two common ones, and ones which might respectively use the SS7 network 20 (FIGS. 1 and 4) and the broadband network 36 (FIG. 4). For convenience in discussion, such dispersed networks that operate through, or in some segments parallel to, the public telephone switching system are herein termed wide area networks (WAN 64).

Continuing with FIG. 5 (background art), a plurality of local loops 50 are typically serviced by each central office terminal 58, and a plurality of specialized networks devices (e.g., Internet routers 62) may be serviced by each central office switch 60. Today, the remote terminal 52 to central office terminal 58, the central office terminal 58 to central office switch 60, and the central office switch 60 to Internet router 62 connections are typically all also T1/E1/DSx lines 54. FIG. 5 includes the specialized network example of an ISP's Internet routers 62 in turn connected to other devices (not shown) by a 10/100/1000 base-T line in the WAN 64. This example presumes the modern practice of directly connecting specialized network devices directly to the central office switch 60 with T1/E1/DSx lines 54. Older installations, smaller ISP's, and other specialized networks may still employ modem banks.

Within this conventional architecture, the recent approach to increasing switching system bandwidth has been development of new technologies. One example is digital subscriber line (xDSL). It increases existing copper wire bandwidth, but by adding yet another set of protocols. It also address the problem in only one segment of the communications architecture, the customer premises 42 to local loop 50 segment, thus making it a stratified approach. This approach uses asynchronous transfer mode (ATM), which requires new hardware throughout the entire communications architecture, and is therefore not a stratified approach. ATM also requires fixed length packets, which is not always efficient when dealing with a variety of data types. ATM may hold great promise for the ultimate future, but it is definitely not an interim or inexpensive solution.

FIGS. 6a-b (prior art) are block diagrams of a current digital subscriber line (xDSL) architecture, wherein FIG. 6a depicts the hardware architecture and FIG. 6b depicts the software architecture. In FIG. 6a, at the customer premises 42 a computer 12d employs an ATM transmission unit—remote (ATU-R 66) to connect via an xDSL interface 68 to an ATU—central (ATU-C 70) in a DSL access multiplexer (DSLAM 72) at the telco central office 56. Further connection is then made via an asynchronous transfer mode network (ATM 74) to a broadband access server (BAS 76) at a network service provider 78. In FIG. 6b, at the customer premises 42 a network protocol 80, point-to-point protocol 82, an ATM adaptation layer (AAL5 84), ATM protocol 86, and asynchronous DSL protocol (ADSL protocol 88) are employed. At the central office 56, the ATM protocol 86 and the ADSL protocol 88 are employed along with a physical protocol 90. At the network service provider 78, another (layer) physical protocol 90, ATM protocol 86, AAL5 84, point-to-point protocol 82, and a network protocol 80 are employed. Some of these layers may be the same and some may be different. For example, the physical protocols 90 usually must be the same on adjacent nodes, and the network protocols 80 usually are the same correspondent nodes.

In summary, the communications architecture used today is quite complex, and getting more so. A myriad of different networks and protocols is already in use, with some being gradually grand-fathered out and emerging new ones growing in importance. It is simply not realistic to expect that old systems will be instantaneously replaced with new ones, and it follows that what is needed are systems for graceful upgrade. Such systems should permit incorporation of both the existing systems and those which are emerging and even yet to be developed.

### SUMMARY OF INVENTION

Accordingly, it is an object of the present invention to provide a system to optimize both packet and time division multiplex (TDM) transmissions in an integrated manner.

Briefly, one preferred embodiment of the present invention is an improved communications system of the type in which a public switched telephone network has communications devices of both circuit switched and packet transfer types at multiple customer premises intercommunicating via at least one telco central office. The improvement is an access network including an access concentrator located at a first customer premises and a transfer switch located at a telco central office. The access concentrator accepts both switched signals from circuit switched types of communications devices and packet signals from packet transfer types of communications devices. The access concentrator communicates both the switched signals and packet signals as a terminating node signal over a first internal interface to the transfer switch. The transfer switch accepts the terminating node signal from the access concentrator and separates the switched signals from the terminating node signal, for transmission onward to instances of the circuit switched communications devices at another customer premises than the first. The transfer switch also separates the packet signals from the terminating node signal, for routing onward to instances of the packet transfer communications devices at another customer premises than the first.

Briefly, another preferred embodiment of the present invention is a method for bandwidth transfer on a public telecommunications network wherein communications devices using switched signals and packet signals are located at multiple customer premises and intercommunicate via at least one telco central office. At least one customer signal is accepted from the communications devices into an access concentrator, wherein each customer signal is a member of the set consisting of switched signals and packet signals. All the customer signals received at access concentrator are integrated into a terminating node signal. The terminating node signal is communicated to a transfer switch. At least one such terminating node signal is accepted at the transfer switch. All the switched signals from the terminating node signal are separated and the switched signals are transmitted onward to instances of the circuit switched communications devices at another customer premises than the first. All the packet signals from the terminating node are also separated and routed onward to instances of the packet transfer communications devices at another customer premises than the first.

Briefly, another preferred embodiment of the present invention is an improved transfer switch for use via at least one telco central office in a communications system of the type in which a public switched telephone network has communications devices of both circuit switched and packet transfer types at a plurality of customer premises that intercommunicate. The transfer switch accepts a terminating node signal from an access concentrator at a first customer premises, wherein the access concentrator has formed the terminating node signal from both switched signals from circuit switched communications devices and packet signals from packet transfer communications devices. The transfer switch separates the switched signals from the terminating node signal for transmission onward to instances of the circuit switched communications devices at a second customer premises. The transfer switch also separates the packet signals from the terminating node signal for routing onward to instances of the packet transfer communications devices at the second customer premises.

Briefly, another preferred embodiment of the present invention is an improved access concentrator for use in a communications system of the type in which a public switched telephone network has communications devices of both circuit switched and packet transfer types at a plurality of customer premises that intercommunicate. The access concentrator accepts both switched signals from circuit switched communications devices and packet signals from packet transfer communications devices. The access concentrator then communicates both of the switched signals and the packet signals as a terminating node signal to a transfer switch located at a telco central office.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF DRAWINGS

The purposes and advantages of the present invention will be apparent from the following detailed description in conjunction with the appended drawings in which:

FIG. 1 (background art) is a block diagram depicting the existing infrastructure of the public switched telephone network (PSTN);

FIG. 2 (background art) is a block diagram depicting the most common digital, or “Internet call,” connection methodology used today;

FIG. 3 (prior art) is a block diagram depicting the presently popular network evolution model, wherein the Internet protocol network evolves to become a single common packet backbone for all communications;

FIG. 4 is a block diagram depicting a proposed more suitable network evolution model, specifically a “Bandwidth Transfer Switching System” (BTSS);

FIG. 5 (background art) is a block diagram of a conventional current digital loop carrier communications architecture;

FIGS. 6a-b (prior art) are block diagrams of a current digital subscriber line (xDSL) architecture, wherein FIG. 6a depicts the hardware architecture and FIG. 6b depicts the software architecture;

FIG. 7 is a block diagram of a transfer switch access architecture according to the present invention;

FIG. 8 is a block diagram depicting a general implementation of transfer node protocol layers for use within the present invention;

FIG. 9 is a block diagram depicting a more specific implementation of transfer node protocol layers for use within the present invention;

FIG. 10 is a block diagram depicting the circuit sub-layer and packet sub-layer bandwidth allocation within the physical layer of the present invention;

FIG. 11 is a block diagram depicting the external interfaces of transfer nodes within the present invention;

FIGS. 12a-b are block diagrams depicting a metropolitan area implementation suitable for use within the present invention, wherein FIG. 12a depicts equipment connections and FIG. 12b conceptually depicts transfer node connection with protocol layering;

FIGS. 13a-b are block diagrams depicting a suburban area implementation suitable for use within the present invention, wherein FIG. 13a depicts equipment connections and FIG. 13b conceptually depicts transfer node connection with protocol layering;

FIGS. 14a-b are block diagrams depicting a rural area implementation suitable for use within the present invention, wherein FIG. 14a depicts equipment connections and FIG. 14b conceptually depicts transfer node connection with protocol layering;

FIGS. 15a-d are block diagrams illustrating how invention permits enhancing and upgrading public switched telephone networks in stages, wherein FIG. 15a shows the existing network, FIG. 15b shows adding centralized transfer nodes, FIG. 15c shows adding customer site transfer nodes and replacing copper interfaces with fiber optic ones, and FIG. 15d shows adding further centralized transfer nodes, particularly to provide high bandwidth capabilities;

FIGS. 16a-b are schematic block diagrams depicting the different functional blocks in transfer nodes, wherein FIG. 16a shows case where all typical elements are provided and FIG. 16b shows the case where all functions marked “Optional” in FIG. 16a are omitted;

FIG. 17 is a schematic block diagram depicting the structure of the transmission path between transfer nodes as well as variable bandwidth allocation in the physical layer;

FIG. 18 is a schematic block diagram depicting how configurations of the BTSS that may not require central office based transfer nodes at all, thus entirely bypassing the PSTN;

FIG. 19 is a schematic diagram stylistically depicting an application of the BTSS for mobile platforms using wireless transmission links;

FIGS. 20a-b are schematic diagrams stylistically depicting applications of the BTSS with wireless transmission links, wherein FIG. 20a depicts connection of two access networks via a single satellite and FIG. 20b depicts connection of access networks via multiple satellites including a repeater;

FIGS. 21a-c are schematic diagrams also stylistically depicting applications of the BTSS with wireless transmission links, wherein FIG. 21a depicts connection of access networks via ground stations, FIG. 21b depicts connection of access networks via multiple ground stations including a repeater station between two access stations, and FIG. 21c depicts connection of access networks via wireless modems and antennas;

FIG. 22 is a schematic block diagram depicting an enhanced central node suitable for resolving address collisions;

And FIG. 23 is a state diagram depicting a suitable address collision resolution system wherein the connected devices can move between different transmission links.

### DETAILED DESCRIPTION

### BEST MODE FOR CARRYING OUT THE INVENTION

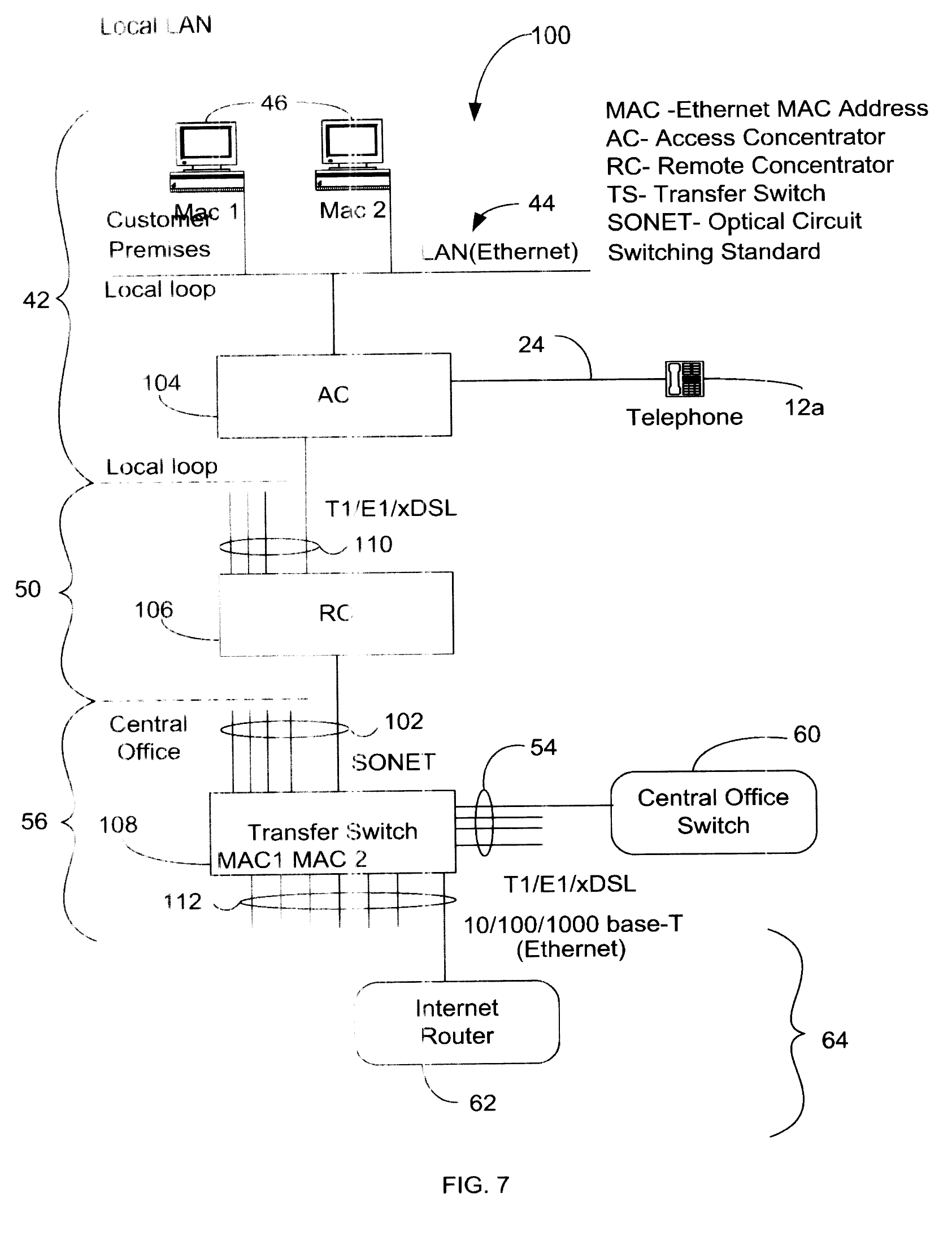

A preferred embodiment of the present invention is a system for optimized packet and time division multiplex transmission and network integration. As illustrated in the various drawings herein, and particularly in the view of FIG. 7, a form of this preferred embodiment of the inventive device is depicted by the general reference character 100.

The present application is a continuation-in-part of application Ser. No. 09/622,252, filed Jan. 4, 2002 (issuance pending), which is a national phase of International Application No. PCT/US00/01039, filed Jan. 14, 2000, which claims the benefit of U.S. Provisional Application No. 60/116,008, filed Jan. 15, 1999. All of which applications are now hereby incorporated by reference. These applications taught the fundamental principles behind the bandwidth transfer switching system (BTSS 100), and provide a number of exemplary embodiments.

To help the reader understand the presently claimed invention, and how it builds upon the original BTSS 100 we start here be representing the original and its exemplary embodiments. The fundamental principle behind BTSS 100 is integrating packet switching capabilities onto the efficient bit-framing techniques implemented in conventional circuit switching technology (e.g., T1/E1 and emerging systems). This approach utilizes the transmission efficiencies of the conventional technology for circuit switching and adds on packet switching capabilities. This basic principle is then adapted to the local loop, where dynamic routing capabilities are not required. This results in a simplified switching system, the BTSS 100, which provides both circuit switching and packet switching capabilities in the local loop while maintaining compatibility with the external interfaces outside the local loop.

As depicted in FIG. 7 the BTSS 100 provides an architecture which may include older types of conventional communications as well as high bandwidth network communications. It permits implementation of efficient heterogeneous networks consisting of both circuit and packet switched technologies in public telephone switching systems. In contrast to the approach of developing entirely new technologies previously discussed in the Background Art section, the BTSS 100 uses time-proven T1/E1/DSx lines 54 (or xDSL, with little modification) from the customer premises 42 into the local loop 50 and then uses SONET 102 (SONET is an optical circuit standard employing fiber-optic cables) to carry the data to the central office 56. Even though the SONET 102 connection is shown as a single link, it will be implemented generally as a fiber optic ring. [Synchronous Digital Hierarchy (SDH) is the ITU specification for SONET, and applies here as well.]Implementation of this architecture requires three new devices: an access concentrator 104, a remote concentrator 106, and a transfer switch 108. Between these new devices, the BTSS 100 employs two communication channels, one for control and management functions and the other for transferring application packets under HDLC framing, wherein the application packets being framed may include Ethernet, TCP/IP, video streams, voice over IP, alarm signaling, meter polling, etc. Alternately, wireline interfaces may be replaced with wireless transmission, namely between access concentrator 104 to the remote concentrator 106, the remote concentrator 106 to the transfer switch 108, and the access concentrator 104 to the transfer switch 108, as well as in extensions with relay nodes (discussed presently). Satellite applications are also possible, in which the remote concentrator 106 is on a satellite and the access concentrator 104 and the transfer switch 108 are terrestrial based, or satellite applications are possible in which either or both of the access concentrator 104 and the transfer switch 108 are on satellites.

To eliminate current bandwidth bottlenecks in both the local loop 50 and the central office 56, and also to provide deployment flexibility and increased network efficiency, the BTSS 100 bifurcates packet switch traffic and circuit switch traffic at the earliest access point outside of the customer premises 42. In this manner, different network architectures, technologies, and deployment strategies can be used in the implementation of data, voice, video, and other services; allowing optimization of specialized networks for different data types. Such specialized network access at the central office 56 is becoming increasingly important. For example, as WAN 64 access to services like the Internet grows. In the following discussion conventional telephone type circuit switch traffic and Internet type packet traffic are used in examples, and the details are thus sometimes specific to these, but the same model can be readily extended and applied to other protocols as well.

A key benefit of the BTSS 100 is enhancement of established network architectures and technologies, such as existing public telephone switching systems, for both circuit switching and packet switching. The BTSS 100 handles circuit switched traffic in substantially the same manner as is currently used (discussed further below), but packet data is handled differently.

Frequently it is desirable for application packet data which originates on an Ethernet local area network LAN 44 (i.e., a “local-LAN”) to be routed to a WAN 64, either for some purpose on the WAN 64 itself or from the WAN 64 onward to another LAN 44 (i.e., a “remote-LAN”). For example, the originating LAN 44 may be a customer premises 42 that is accessing an ISP's network (essentially a simple LAN 44 to WAN 64 and back again situation, which is the example portrayed in FIG. 7), or the packet data may be intended to travel from a first LAN 44 at one customer premises 42 via the WAN 64 onward to a second LAN 44 at a second customer premises 42.

The BTSS 100 accomplishes essentially the same result as the prior art, LAN/WAN or local-LAN/WAN/remote-LAN communications, but it does so differently. Except for spoofing, only physical layer and/or link layer devices (layers 1 and 2 of the ISO Network model) are implemented in the BTSS 100. Upon provisioning, a synchronous control channel (based on HDLC) is established between the access concentrator 104, the remote concentrator 106, and the transfer switch 108. Two types of packet channels are implemented in these special T1/E1/xDSL lines 110, in addition to dedicated circuit channels for voice. One for system control and management functions, and the other for carrying payload. This control channel thus carries provisioning, control, and management information. In particular, this control channel can be used to transparently present the MAC (Ethernet address) of network devices 46 on the LAN 44 via an interface 112 to a WAN 64 during provisioning (e.g., to an Internet router 62).

Once the BTSS 100 is provisioned correctly, the transfer switch 108 monitors the Ethernet traffic on the interface 112 and filters it based on media access control addresses (MAC addresses, i.e., Ethernet addresses), transferring traffic to appropriate remote concentrators 106 for transfer onward to appropriate access concentrators 104, which in turn deliver it onto the LAN 44 having the ultimate target network device 46. In a similar fashion, the access concentrator 104 monitors the LAN 44 traffic and filters it based on MAC addresses, then transfers appropriate traffic onward to the remote concentrator 106 for transfer still onward to the transfer switch 108. The transfer switch 108 then removes the framing and presents the traffic onto the interface 112, or appropriate other application networks, or to the central office switch 60.

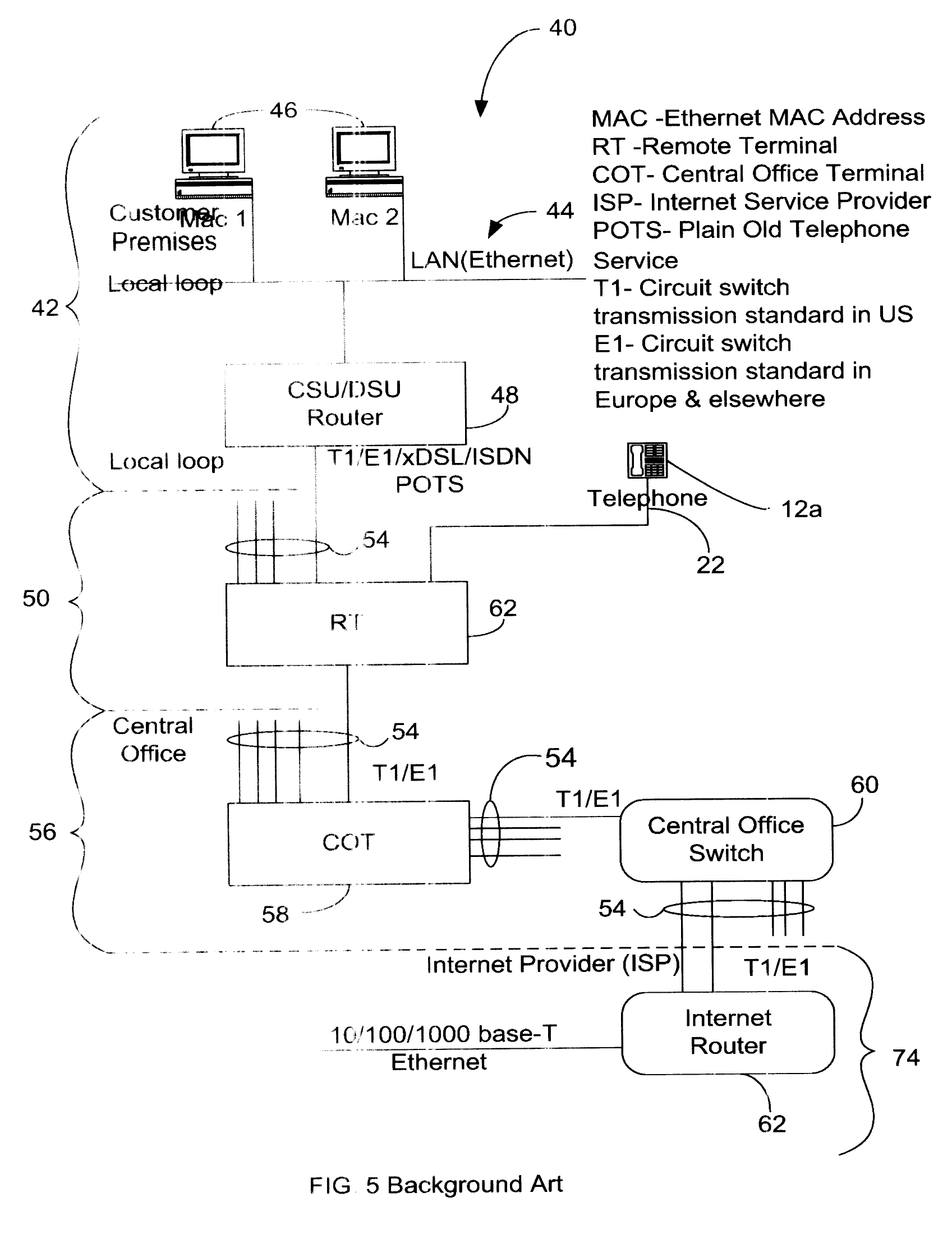

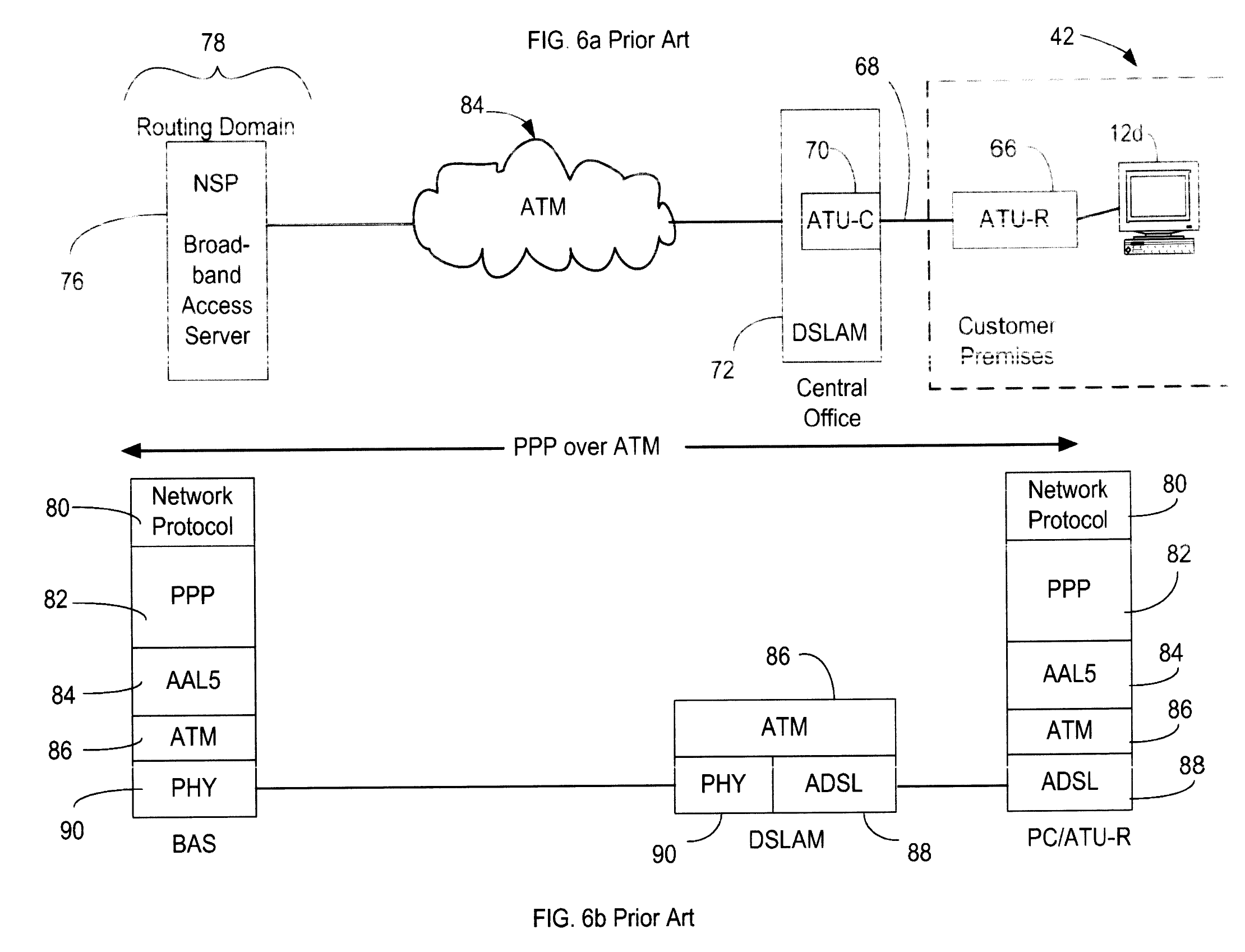

For traffic destined for the WAN 64, this can be done via either a direct transfer switch 108 to WAN 64 connection using the interface 112 shown in FIG. 7, or via a conventional T1/E1/DSx line 54, as shown in FIG. 5 (background art, but in this regard also usable by the BTSS 100). The “payload frames” in this scenario are application packets encapsulated inside an HDLC frame. This will require an access concentrator 104 at the terminating site. Only a single payload HDLC stream between a respective access concentrator 104 and transfer switch 108 is necessary, but redundancy can be provided as desired. The channels available in the T1/E1/DSx line 54 are assigned at provisioning time to specific voice service connections assigned to a subscriber at a customer premises 42. However, every available channel in the T1/E1/DSx line 54 need not be dedicated for service to a particular customer premises 42. Concentration techniques, wherein larger number of subscribers than available channels in T1/E1/DSx lines 54, may also be employed.

The data transfer between a LAN 44 and a WAN 64 only needs to be performed for actual data packets. The control packets can be filtered out by both the access concentrators 104 and transfer switches 108, with appropriate responses being generated as needed, and some traffic through the entire system thereby eliminated. Using the control channel in this manner, the access concentrators 104 are able to communicate with the transfer switches 108 so that the correct status of each network node can be maintained and so that control messages can be spoofed, with this spoofing done by both the access concentrators 104 and the transfer switches 108. Thus, a key point of the BTSS 100 is that “routing” in the traditional sense is not employed at stages between access concentrators 104 and transfer switches 108. The Internet router 62 on the WAN 64 and the network devices 46 on the LAN 44 effectively “see” each other as if they where connected on a simple network. In essence, the BTSS 100 implements a sub-network that has its own intelligence and traffic routing capability between applications and transferring networks.

As previously noted, the BTSS 100 handles analog traffic in essentially the same manner as is currently used. In order to support conventional “telephone” connections, the access concentrators 104 may include the ability to connect POTS lines 24 (and thus POTS devices). The analog traffic (e.g., voice, facsimile, and true modem) can then be either packetized and sent as voice over IP, or transferred using standard DS0 channels using fractional T1/E1 and sent into the local loop 50 on the special T1/E1/xDSL lines 110.

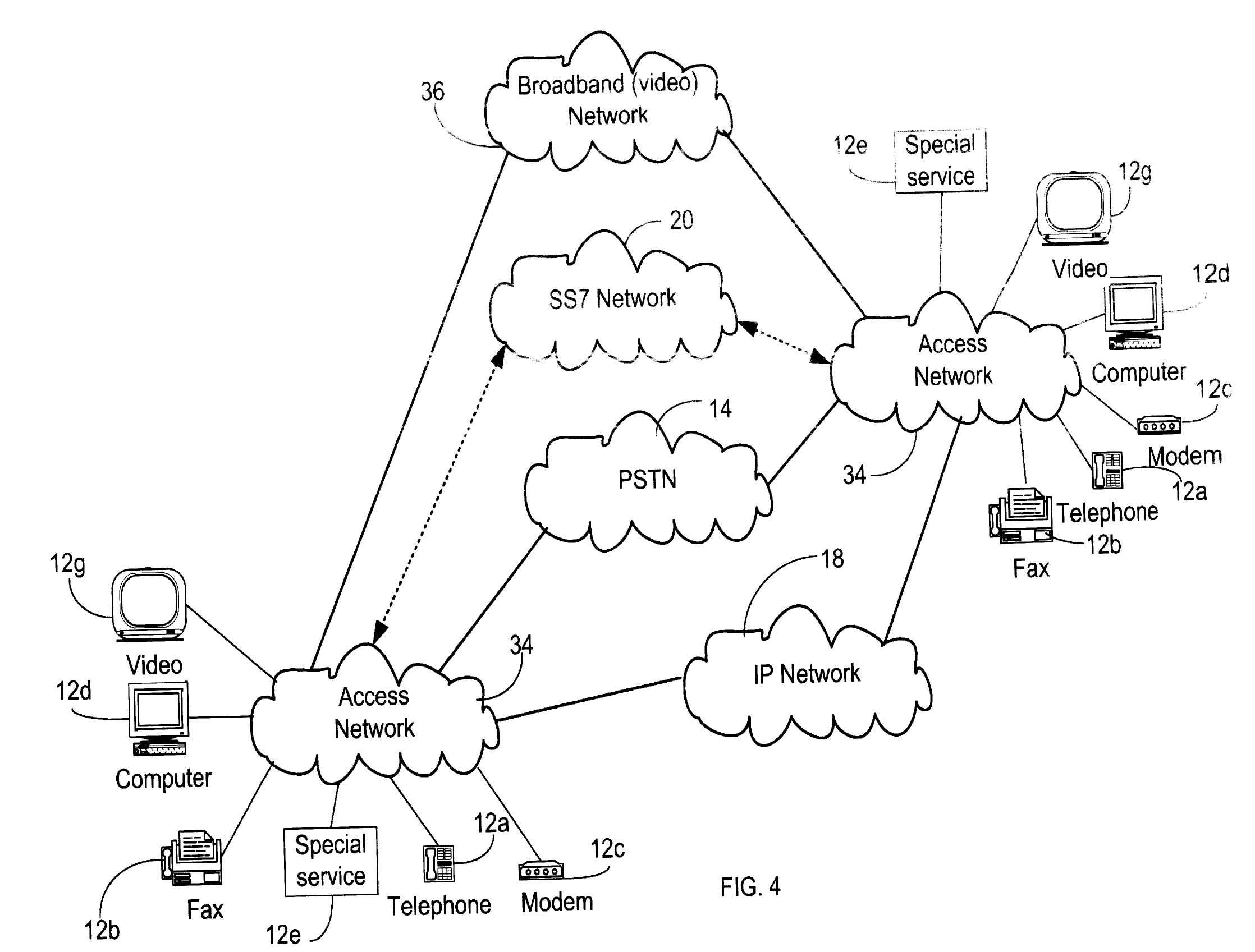

The access concentrators 104 can also provide other types of network connections (not shown), like security alarm and utility meter connections and similar appliance networking which requires only slow speed network access (not shown). These additional network services can also be carried over the local loop 50 and bifurcated at the transfer switch 108, onto appropriate networks providing these services. Services which require higher speeds (e.g., into broadband networks 36 (FIG. 4)), like video services such as Broadcast TV and Video On Demand, can also be similarly provided for in this architecture.

In summary, the approach using the BTSS 100 facilitates using widespread and large scale deployment of time-proven components of T1/E1/DSx technology, while also leveraging the efficiency and high bandwidth of the SONET 102 hierarchy to provide high bandwidth communications and to reduce costs on a per unit basis, compared to other methods in use today.

FIG. 8 is a block diagram depicting a general implementation of transfer node protocol layers for use within the BTSS 100. The access concentrator 104, in the customer premises 42; the remote concentrator 106, in the local loop 50; and the transfer switch 108, in the central office 56, are all connected with respective physical layers 120. These physical layers 120 in turn connect to respective link layers 122. In the access concentrator 104 and the remote concentrator 106 the link layers 122 in turn connect to network layers 124 which each include a POTS sub-layer 126 and packet sub-layer 128. Finally, the access concentrator 104, the remote concentrator 106, and the transfer switch 108 all include a management layer 130.

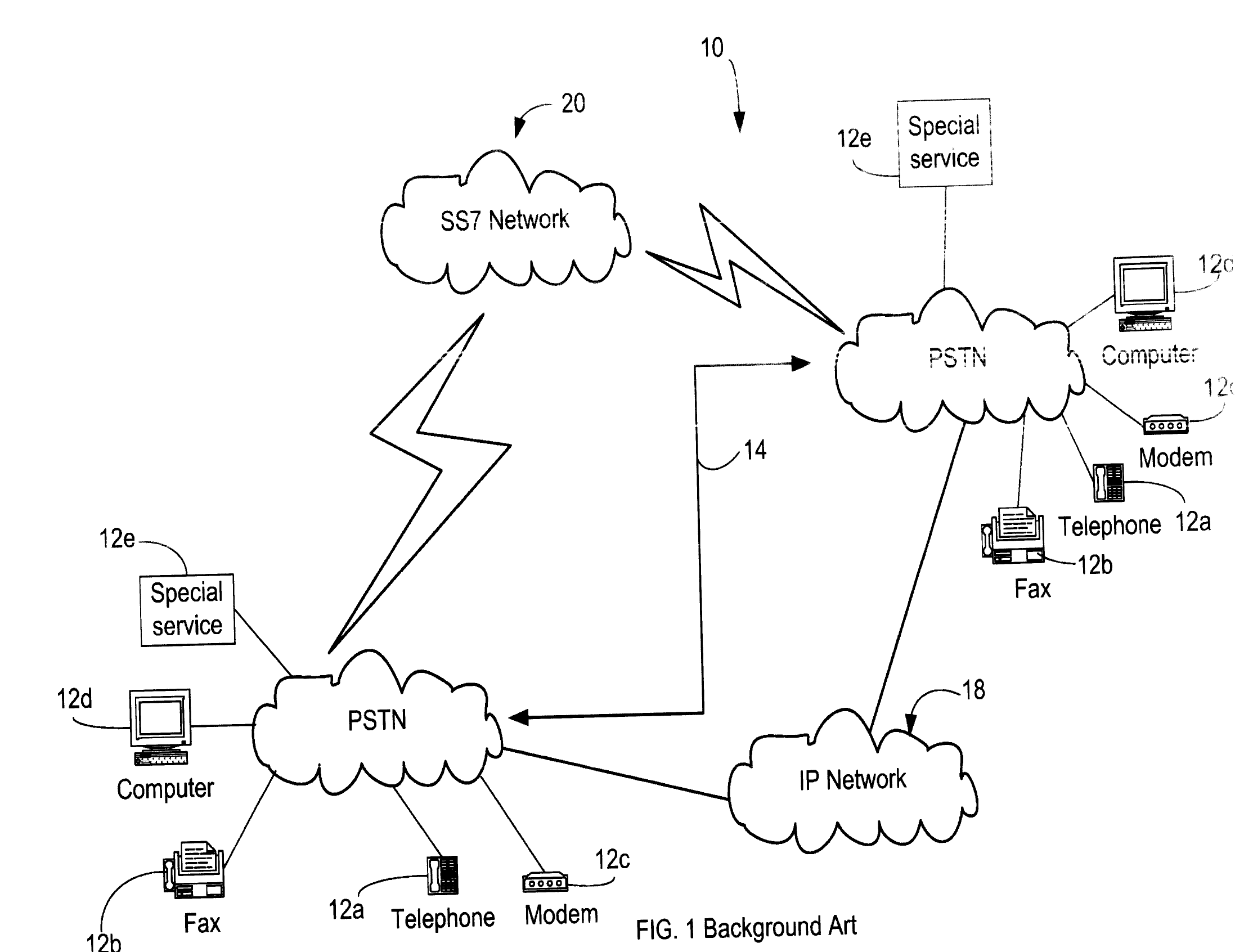

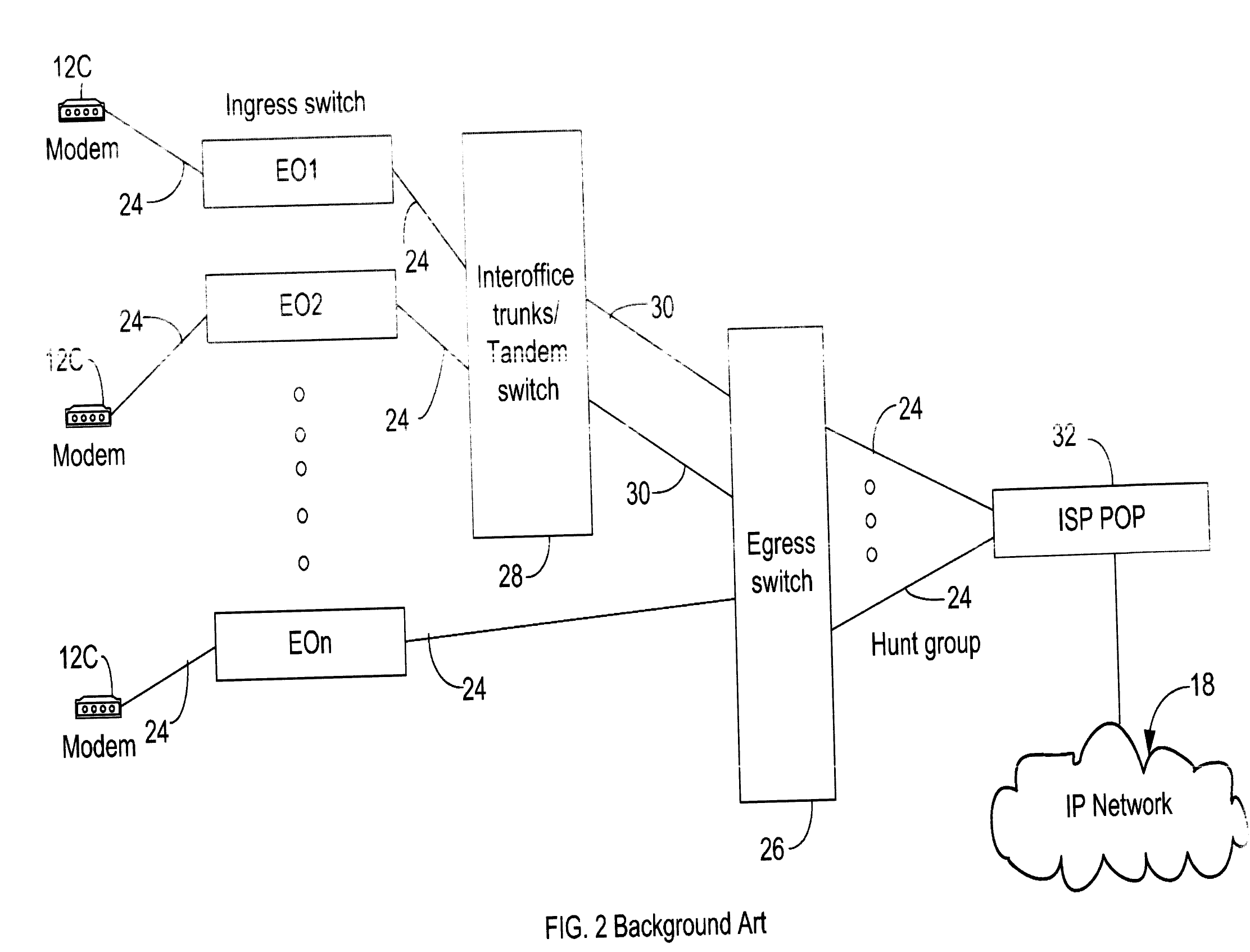

The BTSS 100 maintains compatibility with the existing infrastructure 10 (FIG. 1) of the PSTN completely. With reference again to FIG. 5, in addition to taking into account the requirements of the local loop 50 and eliminating network protocol components which are not required there, the BTSS 100 provides inherent economic advantages over competing high-speed WAN 64 access solutions. Viewed from this perspective, the BTSS 100 needs to provide bridge functionality between three major device categories, namely: the customer premises equipment (CPE 48), the central office switches 60 (e.g., class 5 switches), and carrier class IP routers (e.g., Internet router 62). The external interface for the customer premises equipment (CPE 48) typically includes POTS, RJ-11, RJ-45, and Ethernet protocols. The external interface for the central office switches 60 typically includes POTS, T1/E1, DSx, SLC-96, GR-303, and SONET protocols. And the external interface for the Internet router 62 is some version of Ethernet.

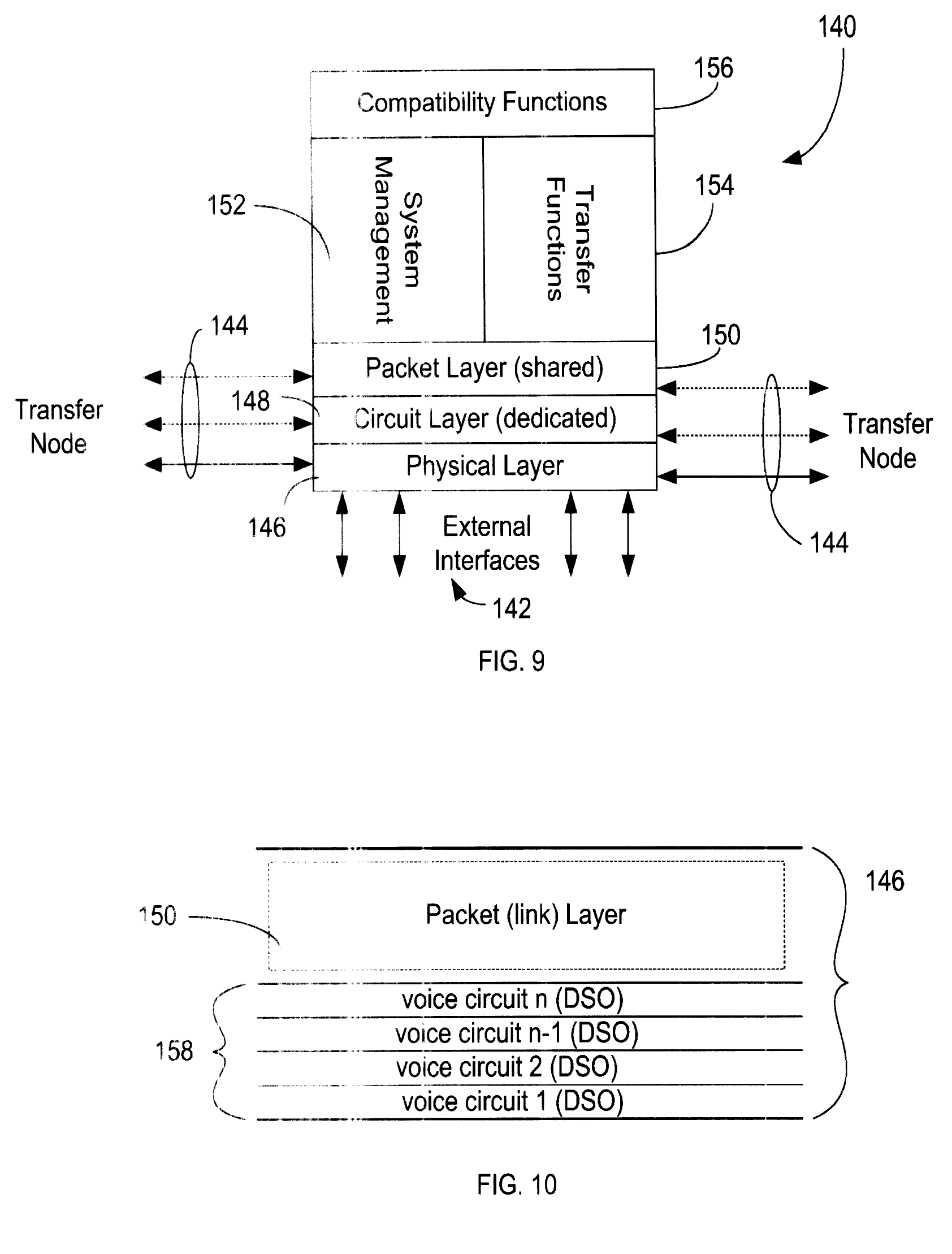

FIG. 9 is a block diagram depicting a more specific implementation of protocol layers in a transfer node 140 for use within the BTSS 100, one which particularly takes into account compatibility functionalities required for interfacing at appropriate external interfaces 142. The transfer node 140 connects to other transfer nodes 140 within the BTSS 100 via one or more internal interfaces 144. A physical layer 146 handles traffic into and out of the internal interfaces 144. The physical layer 146 includes a dedicated circuit sub-layer 148 and a shared packet sub-layer 150. A system management layer 152 or a transfer function layer 154, as appropriate for the respective tasks of management and data transfer, controls the physical layer 146. Finally, a compatibility functions layer 156 “resides” atop all of this and handles traffic into and out of the external interfaces 142.

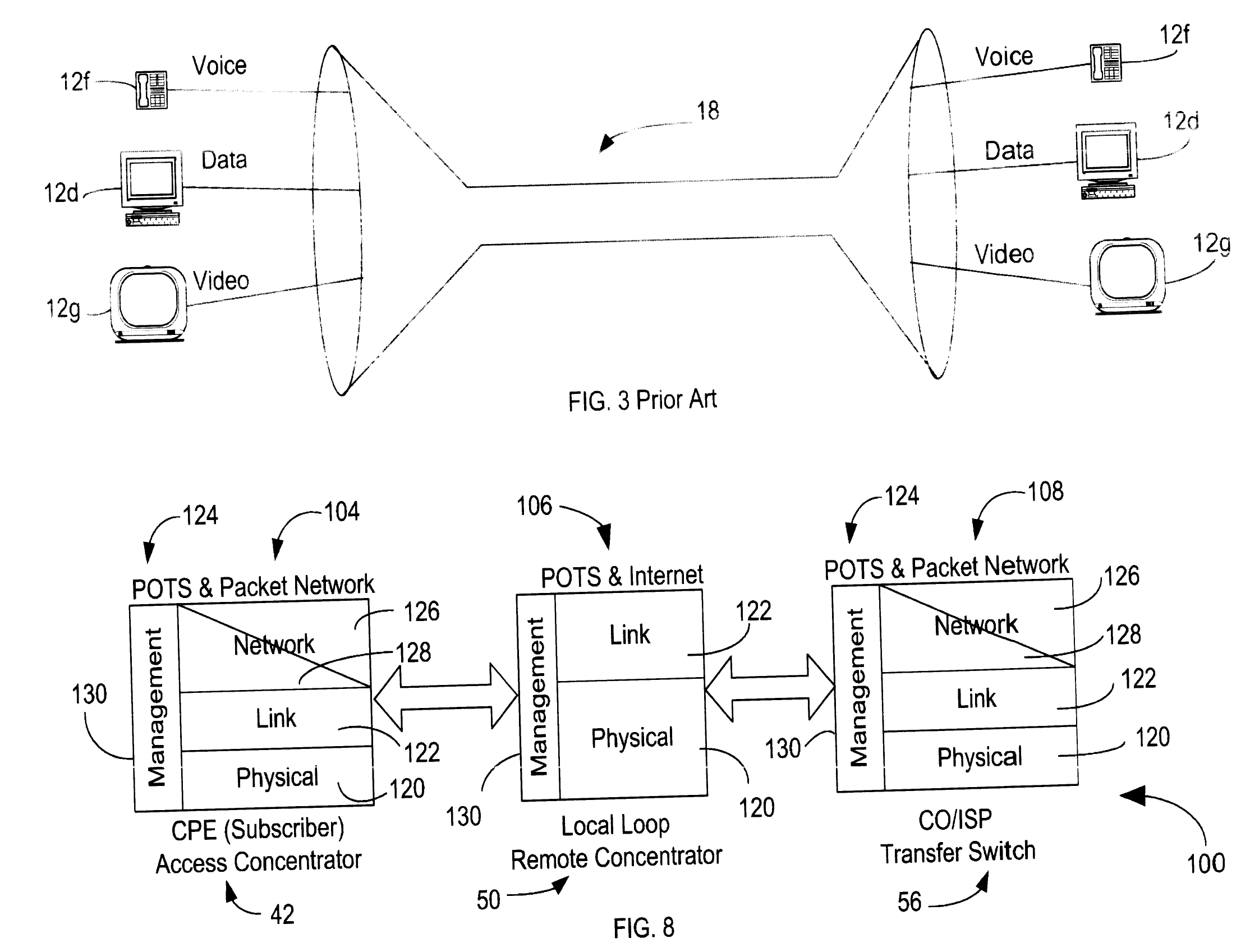

The “generic” transfer node 140 of FIG. 9 may be any one of five different more specific types. One is a customer premises equipment type terminating node, such as an access concentrator 104, which connects to the user's various communications devices (12a-g) (FIGS. 1 and 3-4). A second is a central office type central node, such as the transfer switch 108, which connects to the central office switches 60 (e.g., class 5 switches). A third is an ISP type central node, again such as the transfer switch 108, but which connects to carrier class IP routers (e.g., Internet router 62). A fourth is a distributor type node, such as the remote concentrator 106, which connects only to other nodes of other types. Finally, a fifth is a relay type node which also connects only to other nodes, but not necessarily nodes of other types. The second and third of these, the central office and ISP types, may be implemented in one transfer switch 108 if both communication categories are needed, but this is not a requirement. The distributor and relay type notes do not not have any external interfaces 142 or any layers above the packet sub-layer 150. The relay type notes are included here for completeness, and are discussed in detail presently.

A key principle behind the BTSS 100 is combining circuit switching and packet switching in ways which enhance network capabilities in the local loop 50 (FIG. 7), but with reduced complexity. The functionality is independent of the physical layer connection, and may use the various xDSL technologies, coax, or even wireless to provide physical connectivity. On the physical layer 146, a logical DS1 (T1/E1) scheme may be implemented. This DS1 scheme may provide compatibility with existing OSS (Operations Support Systems). A high-speed Internet service offered with the BTSS 100 can then be managed as a “Consumer DS1” with existing support systems. Some key functions where the DS1 features will be used are service provisioning, alarm detection, monitoring, and propagation. The data rate on the consumer DS1 will vary depending on the particular physical layer 146 which is used.

FIG. 10 is a block diagram depicting the bandwidth allocation within the circuit sub-layer 148 and the packet sub-layer 150 of the physical layer 146. The bandwidth of the physical layer 146 is split into dedicated DS0 channels 158 (e.g., 64 kbps each) for voice and other analog data connections. Each subscriber connection may consist of one or more dedicated DS0 channels 158, and optionally a common channel for the packet sub-layer 150 if data services are enabled. After providing for the dedicated DS0 channels 158, all remaining bandwidth may be used in a single packet sub-layer 150 which may implement a HDLC framed link layer. This may use 16-bit address field and HDLC framing wherein the address field is used to implement multiple logical links, including a control link for implementing management functions.

In this manner, the BTSS 100 may increase efficiency and simplicity by eliminating all dynamic routing requirements between the various transfer nodes 140. Voice calls are carried over the dedicated DS0 channels 158 using standard schemes for implementing voice connections. The assignment of the DS0 channels 158 is done at service provisioning, and for data services (e.g., Internet connection) a logical link is provisioned across all connecting transfer nodes 140, with a unique link layer address for each connecting segment. The available bandwidth in the packet sub-layer 150 is then shared among all the data connections serviced by the segment. Priority schemes may be implemented to provide varying levels of service. The control link used for system management typically will be implemented as a priority link between the transfer nodes 140.

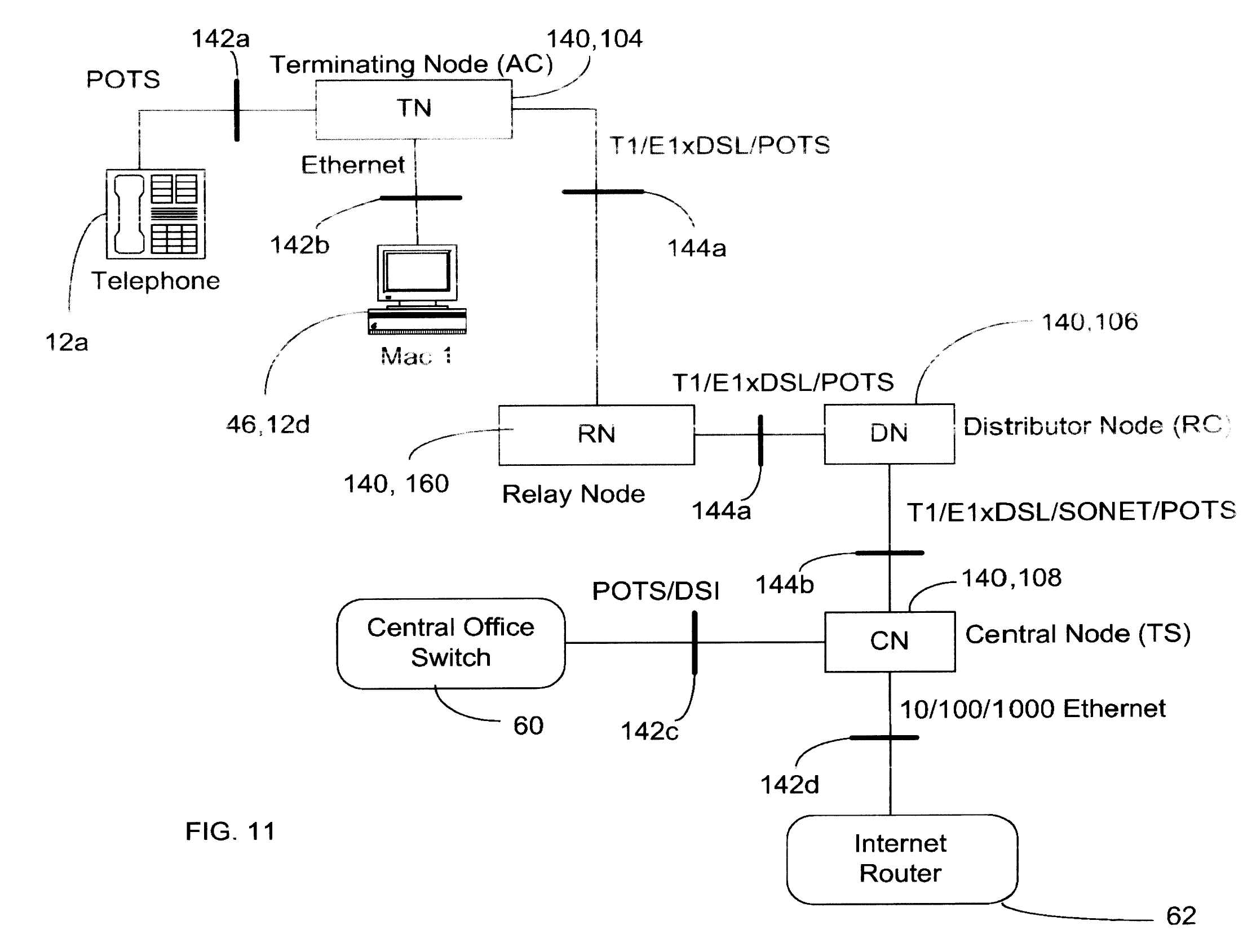

FIG. 11 is a block diagram summarizing typical interfaces in the BTSS 100, and particularly possible ones between the various transfer nodes 140. The transfer nodes 140 include the access concentrator 104 (a terminating node or TN), the remote concentrator 106 (a distributing note or DN), and the transfer switch 108 (a central node or CN). Also included, but not previously described in detail, is a relay node 160 (RN).

An analog user device, specifically the telephone 12a shown, is connected to an access concentrator 104 via an external interface 142a (such as the POTS connection shown). A digital user device, specifically the computer 12d, i.e., a network device 46, is connected to the access concentrator 104 via another external interface 142b (such as the Ethernet connection shown).

The access concentrator 104 is connected to the relay node 160 via an internal interface 144a, and the relay node 160 is connected to the remote concentrator 106 via another internal interface 144a (both shown here as possibly being any of T1, E1, xDSL, or POTS). The remote concentrator 106 connects to the transfer switch 108 via another internal interface 144b (shown here as possibly being any of T1, E1, xDSL, POTS, or SONET; i.e., adding SONET, which is preferred).

The remote concentrator 106 is connected to the central office switch 60 via an external interface 142c (shown here as being either POTS or DS1), and the remote concentrator 106 is also connected to an Internet router 62 via another external interface 142d (shown here as being Ethernet, but with higher speed versions preferred).

The relay node 160 is optional, but may be used when signals are transmitted long distances or need to be enhanced due to electronically “noisy” environments. For example, almost all protocols have some usable distance limitation, with xDSL being particularly notable in this respect.

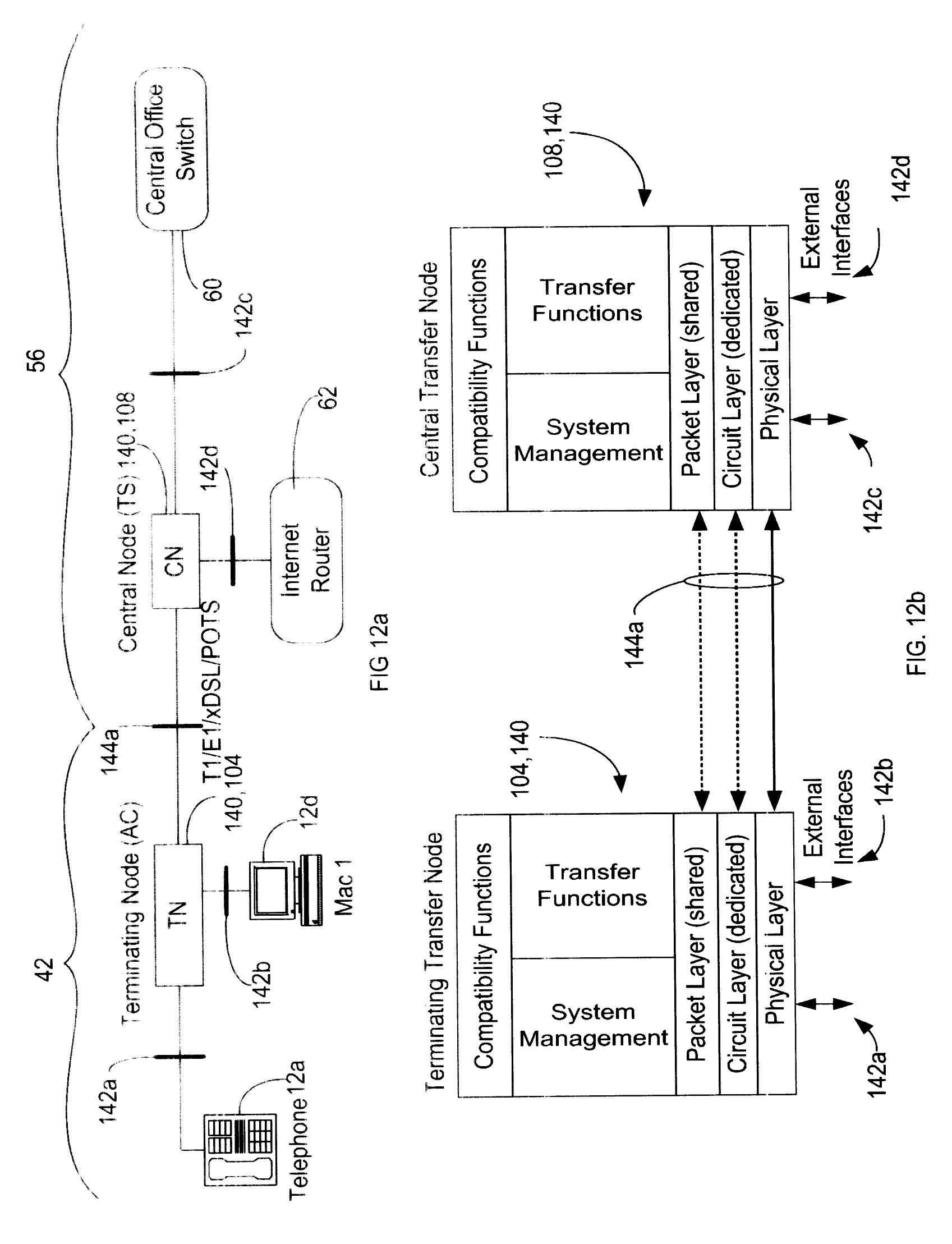

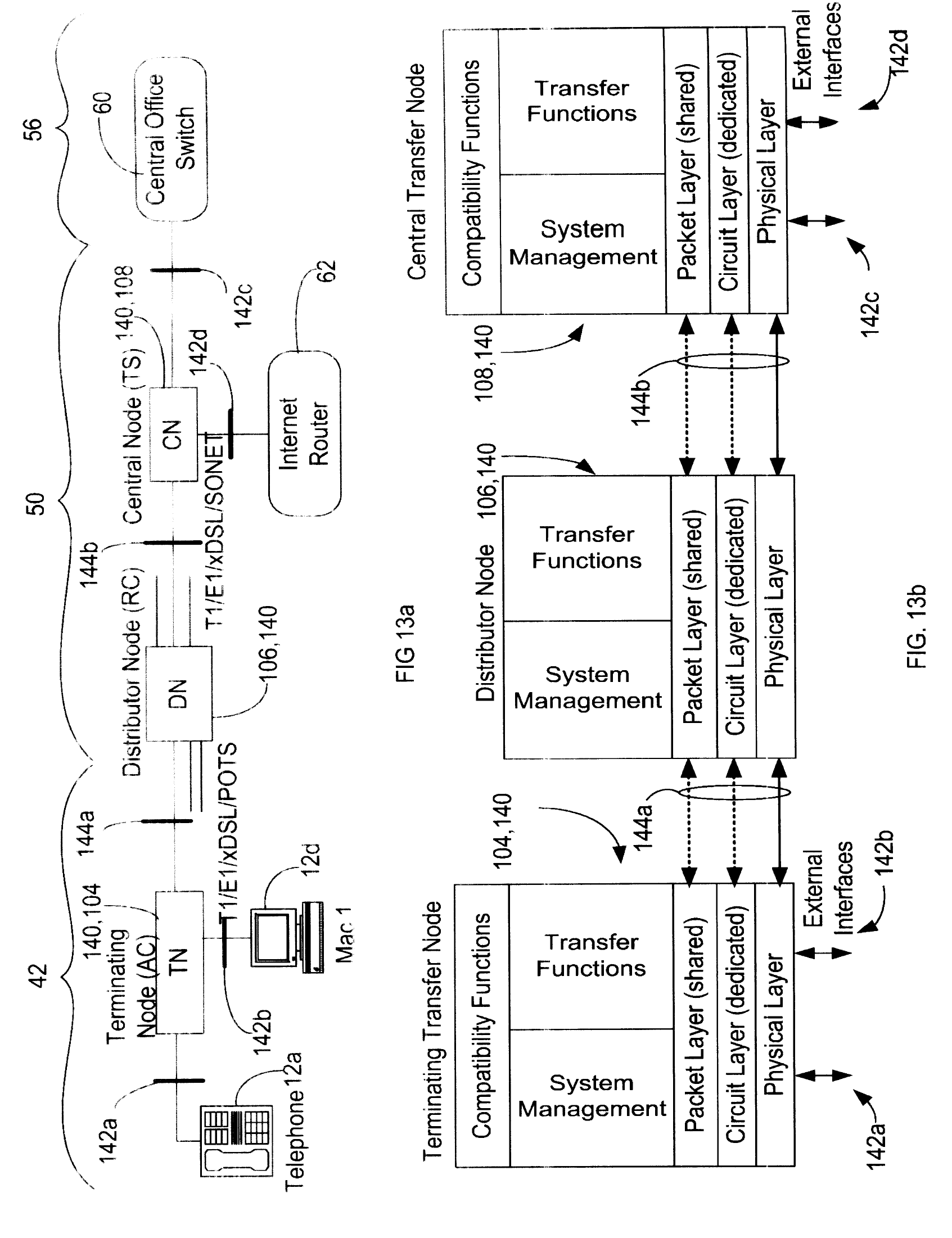

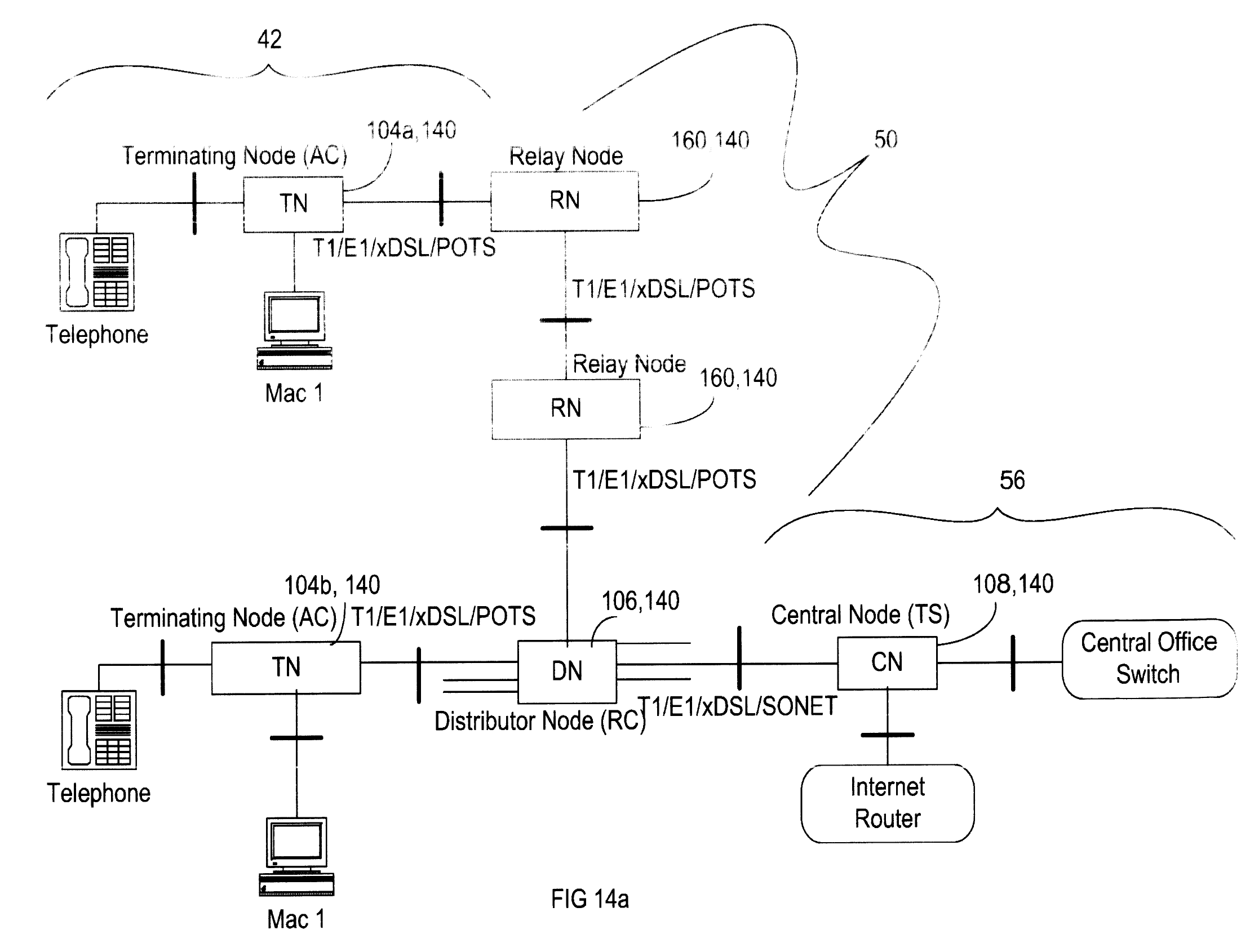

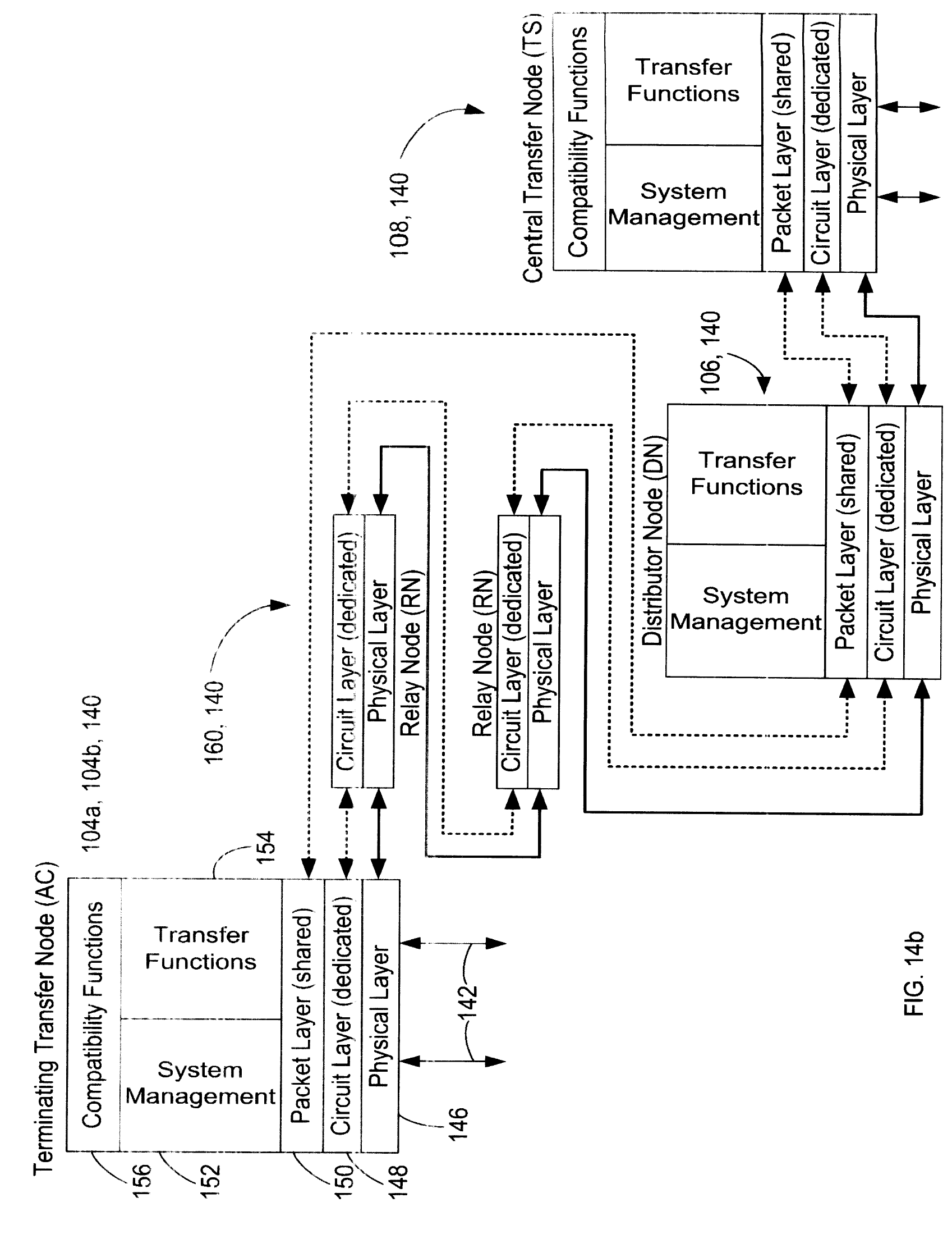

There are several possible deployment configurations for implementation of the BTSS 100 based on different network topology. FIGS. 12a-b show deployment in a typical metropolitan area, where the distance between a central office 56 and a customer premises 42 is short; FIGS. 13a-b show deployment in a typical suburban area; and FIGS. 14a-b show deployment in a typical rural area, where the distance between the central office 56 and the customer premises 42 is considerable and signal regeneration is required.

FIG. 12a is a schematic block diagram showing equipment location for deployment in a typical metropolitan area. The distance between the access concentrator 104 at the customer premises 42 and the transfer switch 108 in the central office 56 is short. This permits elimination of the remote concentrator 106 and any relay nodes 160 (see e.g., FIGS. 11, 13a and 14a).

FIG. 12b is a schematic block diagram showing layer arrangement in the various transfer nodes 140 used in FIG. 12a. As can be seen, both the access concentrator 104 and the transfer switch 108 may have essentially the same layers (122, 124, 126, 128 and 130).

FIG. 13a is a schematic block diagram showing equipment location for deployment in a typical suburban area. Here the distance between the access concentrators 104 at customer premises 42, which may be numerous and more distributed, and the transfer switch 108 in the central office 56 is greater than in the metropolitan area of FIG. 13a. A remote concentrator 106 is therefore provided in this implementation.

FIG. 13b is a schematic block diagram showing layer arrangement in the various transfer nodes 140 used in FIG. 13a. As can be seen, both the access concentrator 104 and the transfer switch 108 may have essentially the same layers (146, 148, 150, 152, 154 and 156), but the remote concentrator 106 does not have a compatibility functions layer 156 or any external interfaces 142.

FIG. 14a is a schematic block diagram showing equipment location for deployment in a typical rural area. Here the distance between a first access concentrator 104a at a first customer premises 42 and the remote concentrator 106 is considerable. Two relay nodes 160 are therefore added between the first access concentrators 104 and the remote concentrator 106. This is particularly useful for protocols like xDSL, which are severely distance limited. In contrast, a closer second (third etc.) access concentrator 104b may directly connect to the remote concentrator 106, as shown.

FIG. 14b is a schematic block diagram showing layer arrangement in the various transfer nodes 140 used in FIG. 14a. As can be seen here, the access concentrators (104a, 104b) and the transfer switch 108 may have essentially the same layers (146, 148, 150, 152, 154 and 156), the remote concentrator 106 lacks a compatibility functions layer 156 and external interfaces 142; and the relay nodes 160 have only physical layers 146 and circuit sub-layers 148. In this case, the relay nodes 160 may implement the physical layers 146 and circuit sub-layers 148 using the bit frames and embedded control channels implemented as in regular T1/E1 interfaces. The embedded control channel may support alarm monitoring, detection, and propagation from the access concentrators (104a, 104b) to the transfer switch 108. The relay nodes 160 thus allow extending the distances over which service can be provided, potentially without any limit.

The BTSS 100 can be particularly useful in reducing the current IP address shortage, in enhancing network security, providing unified directory services, and handling additional number services.

Returning to FIG. 7, it can be seen there that the access concentrator 104, remote concentrator 106, and transfer switch 108 form a hierarchical boundary in a given service area. This can be highly useful to reduce the current IP address shortage. At the first level, the access concentrator 104 provides connectivity to a LAN 44 at the customer premises 42. This LAN 44 can be implemented either as a “closed network” or “open network.” If it is desirable to provide open access to all of the systems at the customer premises 42 from the outside, then a way to provide addressing is to use globally unique IP addresses (RFC 1918, BCP 5) which are routable across the WAN 64, e.g., the Internet. But if such systems are meant to have limited access then a way to provide addressing is to use the non-routable private IP addresses. The remote concentrator 106 and the transfer switch 108 form logical network access control points to and from the outside service area covered by each remote concentrator 106 or transfer switch 108. By providing private IP addresses as the default addressing scheme for networks crossing the local loop 50, the BTSS 100 technology, if widely deployed, can drastically reduce the need for unique IP addresses. Since all the transfer nodes 140 (FIG. 11) are non-routing with respect to customer data, this implementation is independent of user device addressing schemes. Implementing Network Address Translation (NAT) along with private IP addresses thus allows for significantly reducing the current IP address shortage.

The BTSS 100 also facilitates providing heightened network security and privacy. By implementing a NAT (Network Address Translation) on a central transfer switch 108, each subscriber may be provided an isolated LAN 44 with built-in security. Enhanced security features such as proxy servers can be implemented on the transfer switch 108 for added security needs. The remote concentrator 106 and the transfer switch 108 becomes a natural network access point for implementing the various protection and access control techniques available for implementing network security and privacy features. In addition, the access concentrator 104, remote concentrator 106, and transfer switch 108 form network access control points. This allows implementation of uniform network access control methods for varying levels of security needs. Since these devices are on the outer perimeter of any connected networks, e.g., the LAN 44 and WAN 64, the security capabilities implemented can enhance any additional security measures implemented within such connected networks. In addition, being on the outer perimeter of such connected networks, the transfer nodes 140 are capable of implementing network isolation, intrusion detection, and firewall schemes as fundamental functions.

As the various ways we use to communicate increases, providing unified directory services becomes increasingly desirable. Telephone companies have long implemented universal and easily accessible systems for distributing subscriber information, e.g., phone numbers, directory assistance, etc. These telephone numbering plans and the associated directory services provide a comprehensive set of tools for making the PSTN 14 (FIG. 1) useful. With the public WANs 64, such as the Internet, becoming increasing commonplace, the need for similar directory services is becoming obvious. Currently, the domain names and e-mail addresses used are being distributed or published in an ad hoc manner, and thus lack the universal reach and uniformity available with telephone directory-type methods. However, by linking a customer telephone to all such WAN (particularly Internet) related identification information, a customer who wishes to publish (privately or publicly) can simplify or avoid the current problems relating to the dissemination of their identification information. Appropriate embodiments of the access concentrator 104 can enable the customers to configure the selected identification information to be associated with their telephone number. Appropriate embodiments of the transfer switch 108 can then make this information available to the telephone operations systems, making it available as additional information available about the customer. The information thus provided can either be manually retrieved, e.g., via conventional operator assistance techniques, or the transfer nodes 140 can use the telephone number as a key identifier to provide directory lookup services.

Similarly, as the various services we use to communicate increases, the quantity of dedicated additional telephone numbers we require for such is becoming unwieldy. However, in the BTSS 100, the terminal transfer nodes 140 can provide more than one POTS connection on each customer line. This permits providing additional telephone lines, such as dedicated ones for fax and pager services, but without the need for dedicated telephone numbers. While having dedicated circuits assigned for each specific type of service (fax, pager, second line, etc.), under the BTSS 100 there is no need to provide separate numbers for each. The service type can be identified either at the access concentrator 104 or at the transfer switch 108. The PSTN 14 can route the call to the customer telephone number like any other call. And the terminal transfer nodes 140 can appropriately terminate the call based on its particular type. In this manner, the need for different telephone numbers for each different service may be eliminated. Large scale deployment of these capabilities can reduce the need for separate telephone numbers, thus reducing the current number shortage.

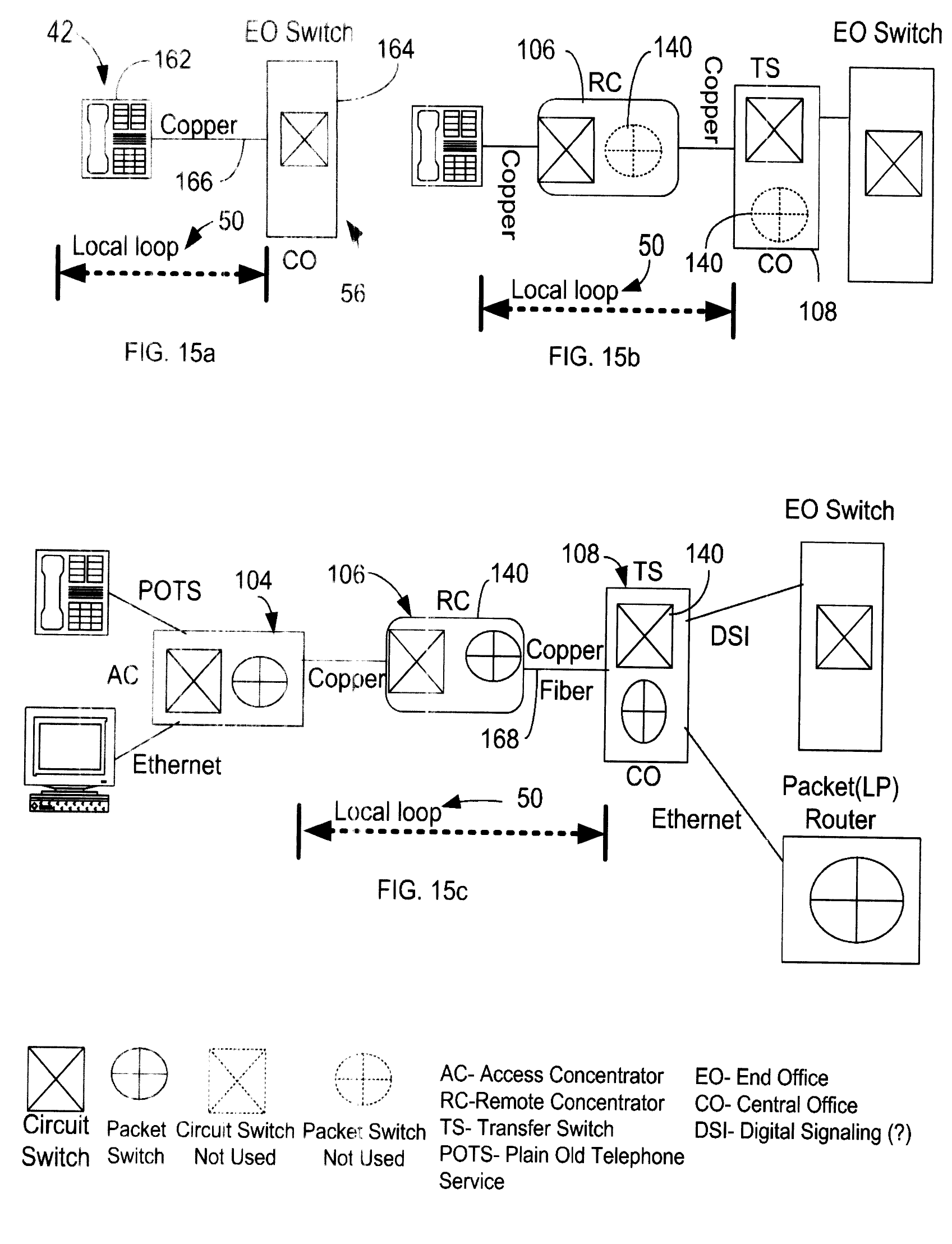

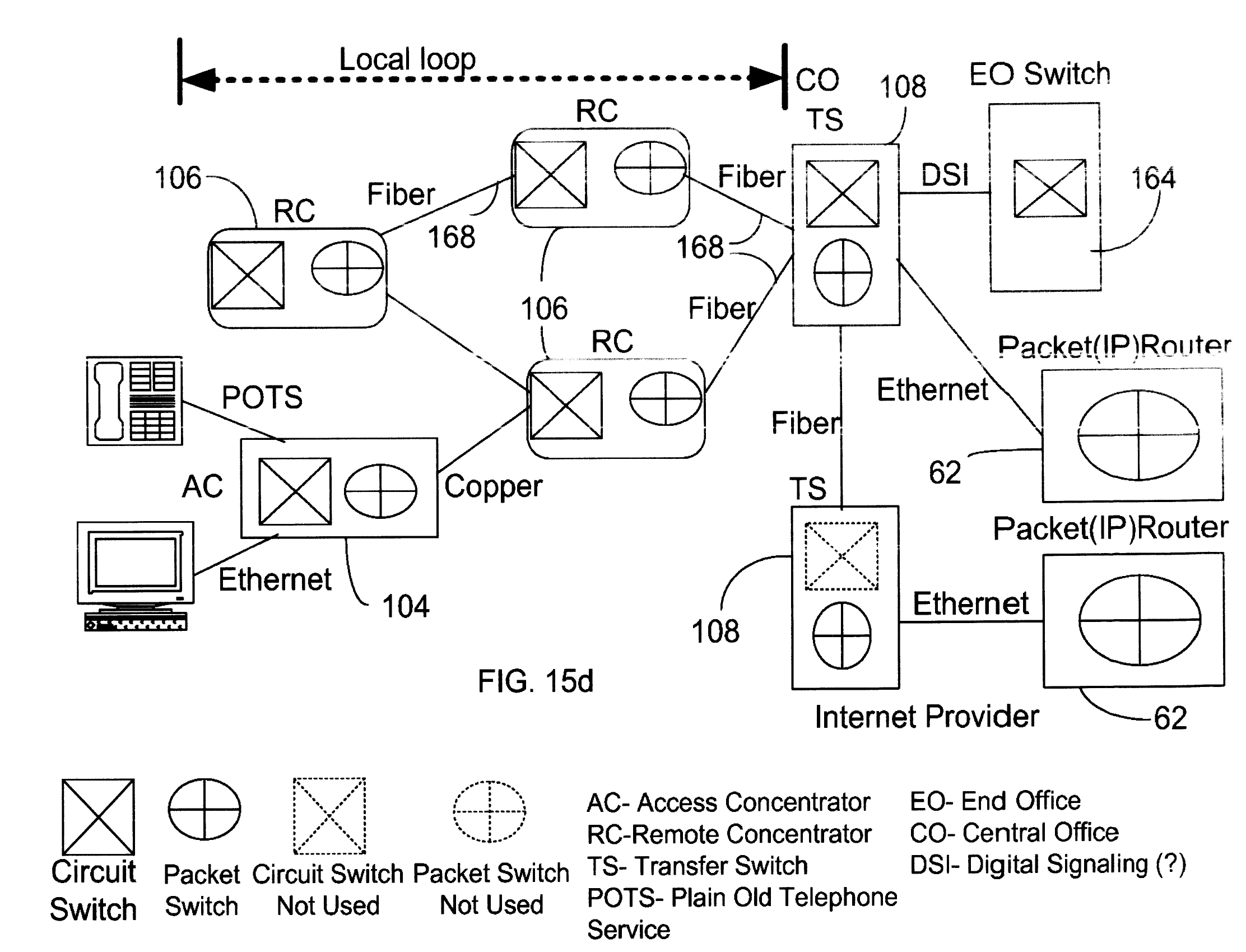

FIGS. 15a-d illustrate how the BTSS 100 permits enhancing and upgrading the local loop 50 in stages. Currently, the technology implemented in the local loop 50 addresses only voice service needs. Providing the next generations of services requires enhancing and upgrading the local loop to offering voice, data, and video services. This is a huge effort in terms of time and resources, and the only practical way to achieve such enhanced capabilities is by implementing them in stages. FIGS. 15a-d show how this upgrade and enhancement can be implemented in five steps. FIG. 15a shows step 0 (the existing situation), wherein local loop 50 consists of customer equipment 162 at the customer premises 42, an end office unit 164 in the telco central office 56, and copper wire lines 166 connecting these. FIG. 15b shows a step 1, wherein the transfer nodes 140 are deployed in the local loop 50, but offering only POTS type services. FIG. 15c shows a step 2, wherein data (e.g., Internet) services are additionally offered by adding access concentrators 104. FIG. 15c also shows a step 3, wherein the bandwidth limitations in the local loop 50 are eliminated by deploying fiber optic lines 168 (e.g., SONET) between the central transfer nodes 140 (e.g., the remote concentrator 106 and transfer switch 108). Finally FIG. 15d shows a step 4, wherein additional remote concentrators 106 are deployed to provide high bandwidth services (e.g., HDTV, video) and for additional service selections which employ flexible and reconfigurable sub-networks in the local loop 50 using the network of transfer nodes 140.

The following is a simplified outline of the functions of the access concentrator 104: connection to POTS telephones; TCP/IP interface over Ethernet; T1/E1/xDSL interface to the remote concentrator 106; establish and manage the control channel to the transfer switch 108; optional dynamic channel allocation of the available bandwidth between packet and voice time division multiplexing (TDM) traffic, or voice over IP; conversion and transmission of Ethernet packets from the LAN 44 into HDLC framed packets to the transfer switch; conversion and transmission of remote HDLC packets from the transfer switch 108 to Ethernet packets in the LAN 44; managing and maintaining Ethernet MAC address conversion to and from HDLC addresses; spoofing network control packages addressed to all remote devices which are currently active (this requires partial IP level filtering and processing); compression and decompression of different data types; encryption of secure data and management and processing of digital certificates for authentication; and combination of different traffic types, e.g., analog, voice, video, data, etc., into data streams.

The following is a simplified outline of the functions of the remote concentrator 106: multiple T1/E1/xDSL interfaces to multiple access concentrators 104; DSx/xDSL/SONET interfaces to transfer switches 108 at the central offices 56; maintaining the control channel between the transfer switch 108 and the remote concentrators 106; and dropping and inserting T1/E1/xDSL interfaces from the access concentrators 104 into the SONET interfaces.

The following is a simplified outline of the functions of the transfer switch 108: maintaining multiple T1/E1/DSx interfaces from multiple remote concentrators 106; maintaining multiple 10/100/1000 base-T interfaces to Internet routers 62 (for data traffic); maintaining multiple T1/E1/DSx interfaces to central office switches 60 (for voice data); establishing and managing the control channels (through HDLC framed links) to access concentrators 104; accepting Ethernet MAC addresses from the access concentrators 104 and presenting them on the 10/100/1000 base-T interface to Internet routers 62; controlling and managing TDM voice calls to the access concentrators 104, alternatively providing voice over IP; spoofing network control packages addressed to all remote devices which are currently active (this requires partial IP level filtering and processing); compressing and decompressing different data types; encryption of secure data and management and processing of digital certificates for authentication; separating the data streams back into the original different traffic types, e.g., analog, voice, video, data, etc., for transfer to different application networks, e.g., central office switch 60, Internet router 62, alarm system, utility company meter polling, etc.

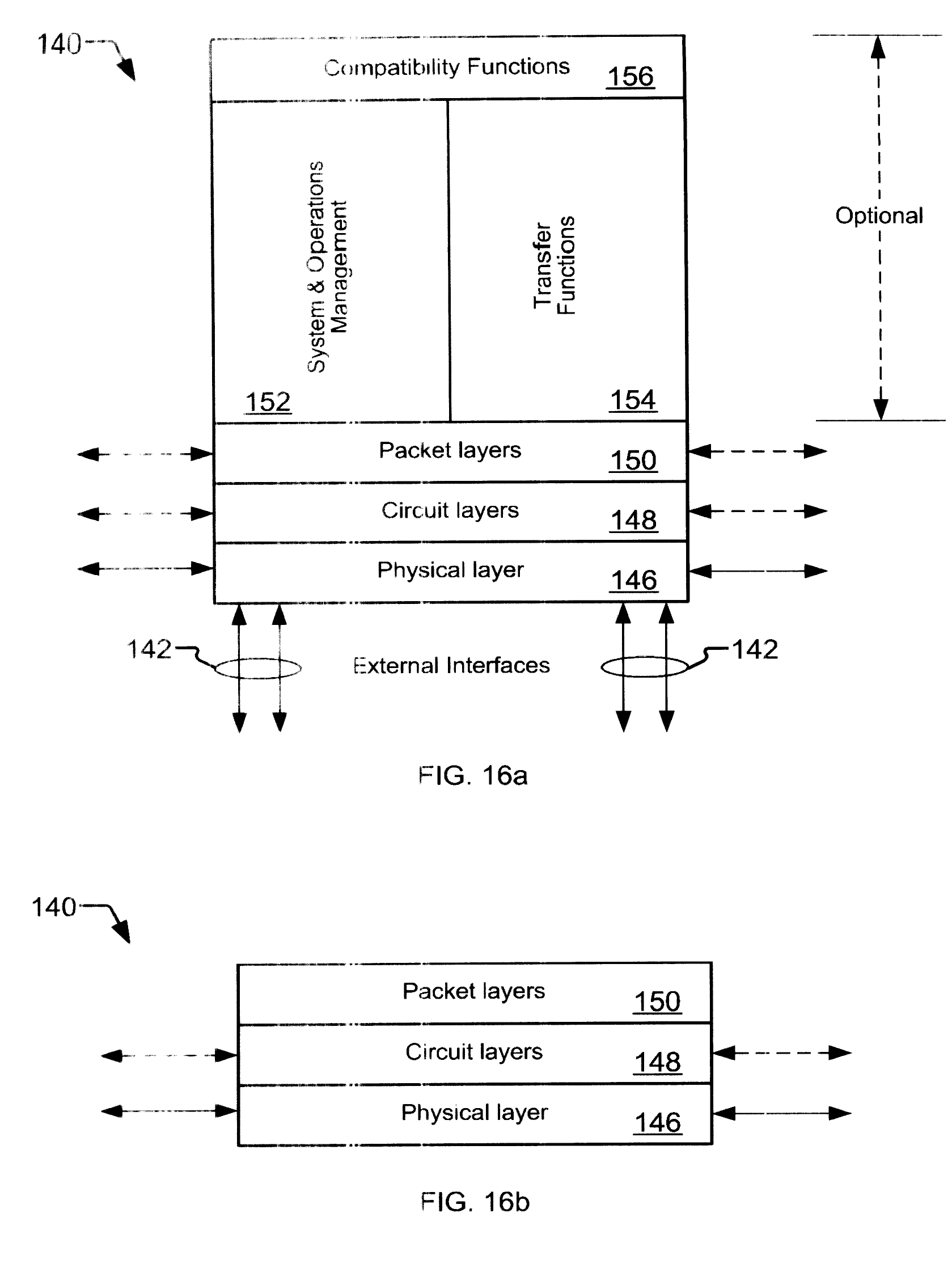

FIGS. 16a-b are schematic block diagrams depicting the different functional blocks in transfer nodes 140. FIG. 16a is essentially the same as FIG. 9, and FIG. 16b emphasizes the cases where all functions marked “Optional” in FIG. 16a are omitted (particularly used for the relay node 160). These figures are useful for recapping the four types of devices that the generic transfer node 140 can represent: a terminating node (TN), the access concentrator 104; a central node (CN), the transfer switch 108; a distributor node, the remote concentrator 106 (RC); and the relay node 160 (RN).

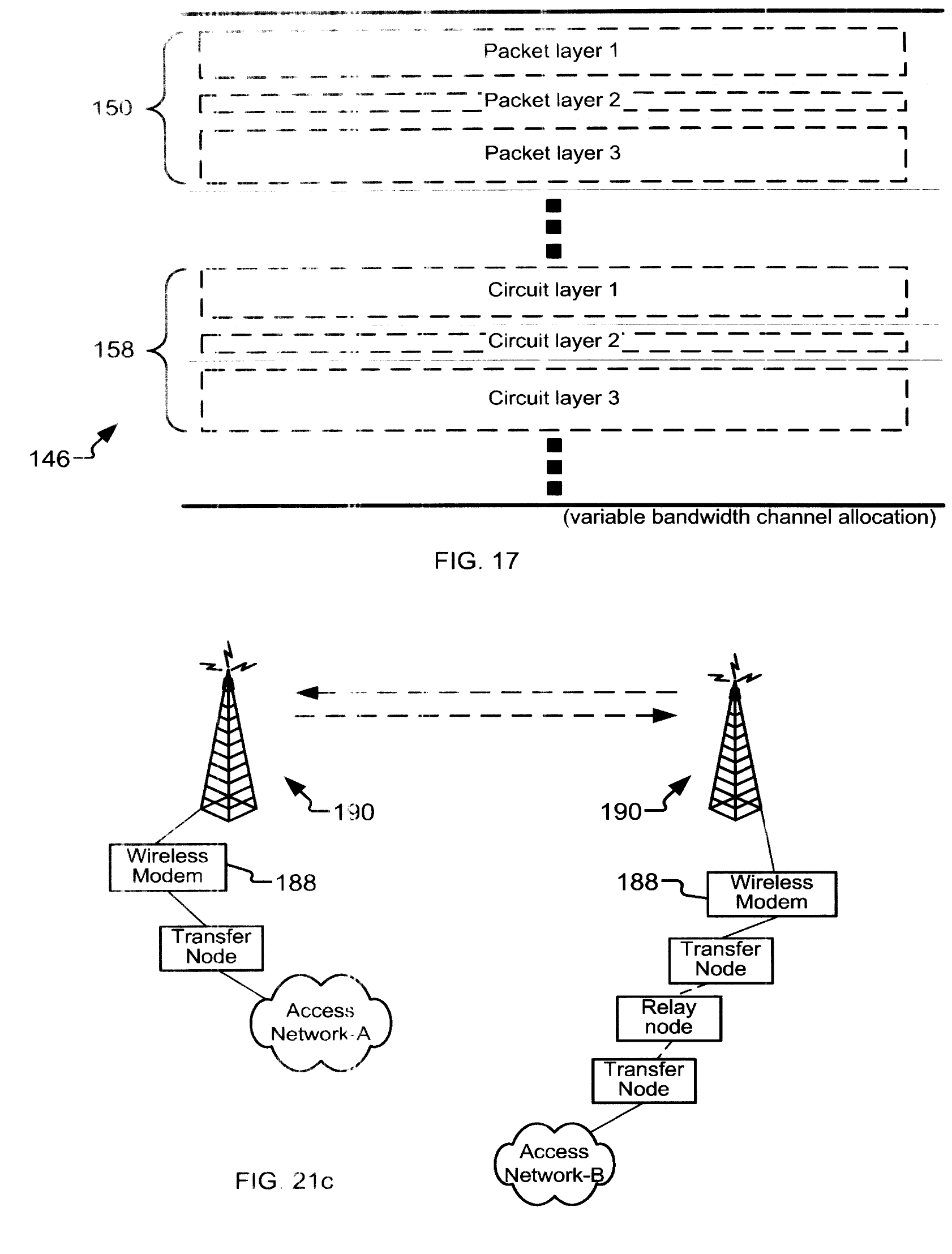

The differences are in the functionality implemented in each of these devices to build the BTSS 100, which we can summarize as follows. The access concentrator 104 (terminating node) provides standard (non-transfer node) interfacing to network devices, and provides address mappings and/or translations for data transfer across the BTSS 100 without need for native (non-transfer node) routing. The transfer switch 108 (central node) provides traffic aggregation, and data transfer cross-connections between access concentrators 104, remote concentrators 106, relay nodes 160, and other transfer switches 108. These also provide centralized network management functions, such as address collision resolution (discussed presently). The primary function of the remote concentrator 106 (distributor node) is traffic concentration and optimization among multiple access concentrators 104. And the relay node 160 is a simplified transfer node used for extended transmission of transfer connection signals (FIG. 17). The functions marked “optional” in FIG. 16a will usually not be present in relay nodes 160 (as FIG. 16b emphasizes), and may also be absent in some of the other types of transfer nodes 140, as needs require.

FIG. 17 is a schematic block diagram depicting the structure of the transmission path between transfer nodes 140 as well as variable bandwidth allocation in the physical layer 146, specifically, allocation for transfer connection signals. FIG. 17 resembles FIG. 10, but includes additional detail in packet link layer (the packet sub-layer 150) and the circuit switched layer (the DS0 channels 158).

FIG. 18 is a schematic block diagram depicting how configurations of the BTSS 100 that may not require central office based transfer nodes 140 at all, thus entirely bypassing the PSTN 14 (FIG. 4). This particularly also shows the extended transfer network topology that can be achieved beyond the traditional central office based digital loop carrier architecture.

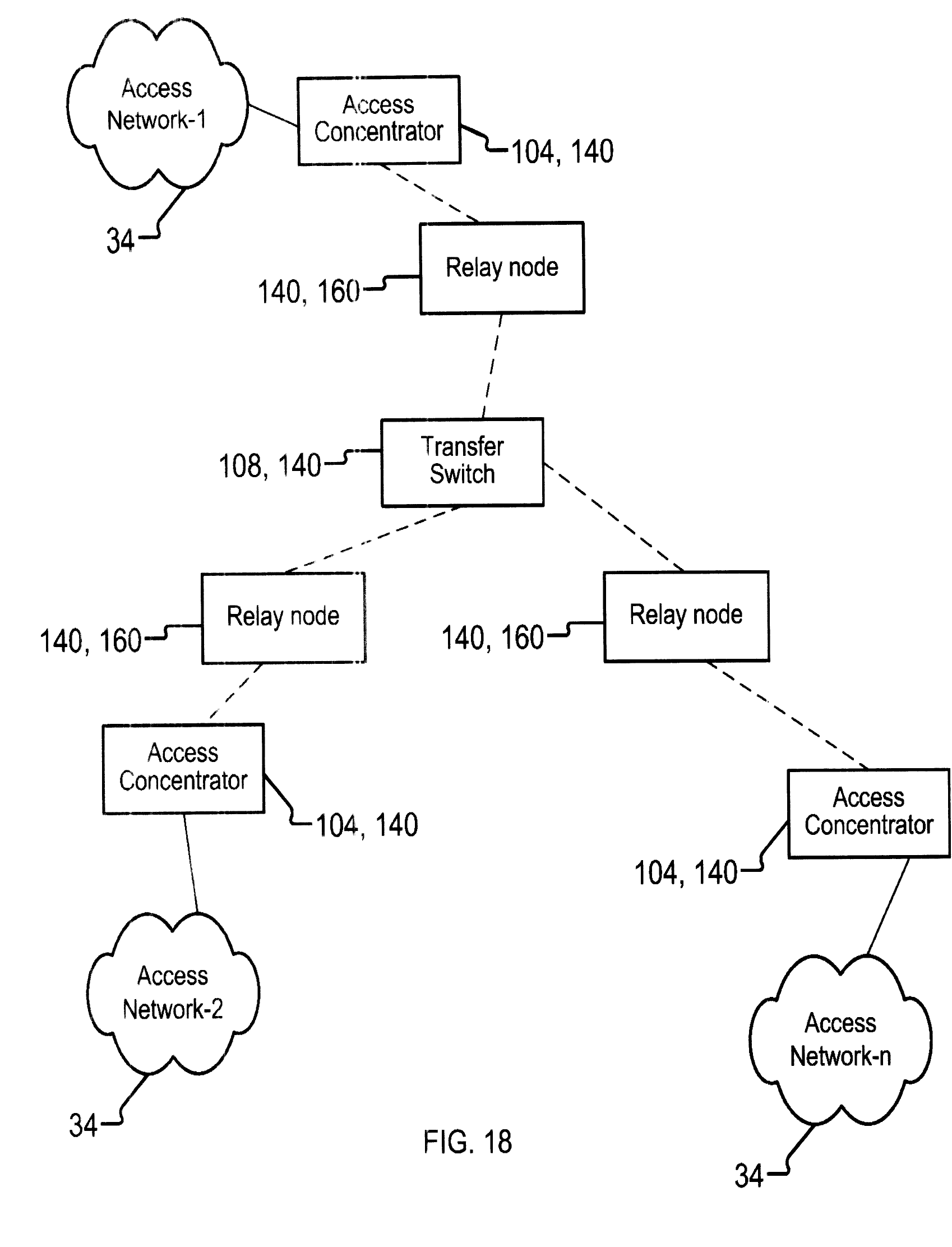

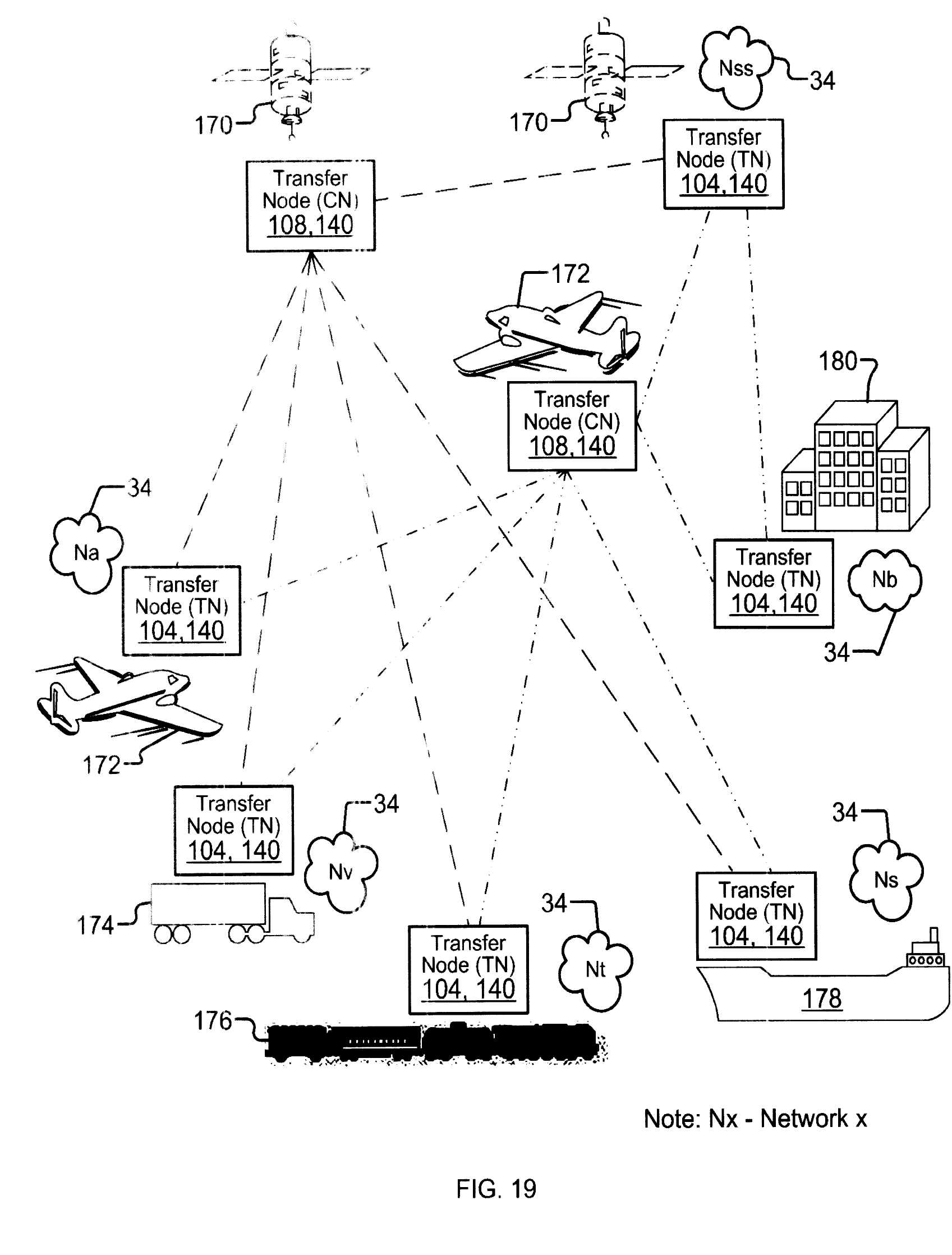

FIG. 19 is a schematic diagram stylistically depicting an application of the BTSS 100 for mobile platforms using wireless transmission links. In this exemplary representation two transfer switches 108 (central nodes, CN) are present in a satellite 170 and an aircraft 172. Both of these transfer switches 108 are able to service all of the access networks 34 present, each including an access concentrator 104 (terminating node, TN). The respective access networks 34 here are in another aircraft 172 (Na), a road vehicle 174 (Nv), a train 176 (Nt), a ship 178 (Ns), a building 180 (Nb), and another satellite 170 (Nss). The use of two central nodes (transfer switches 108) is not required, but provides a useful backup capability. For instance, if sun spot activity disrupts the ability to use the one central node in the satellite 170, the other central node in the aircraft 172 can substitute. Conversely, if inclement weather of action by hostile forces disables or precludes use of the central node in the aircraft 172, the other central node in the satellite 170 can substitute (perhaps having this capability but generally using its resources for other tasks until if and when needed).

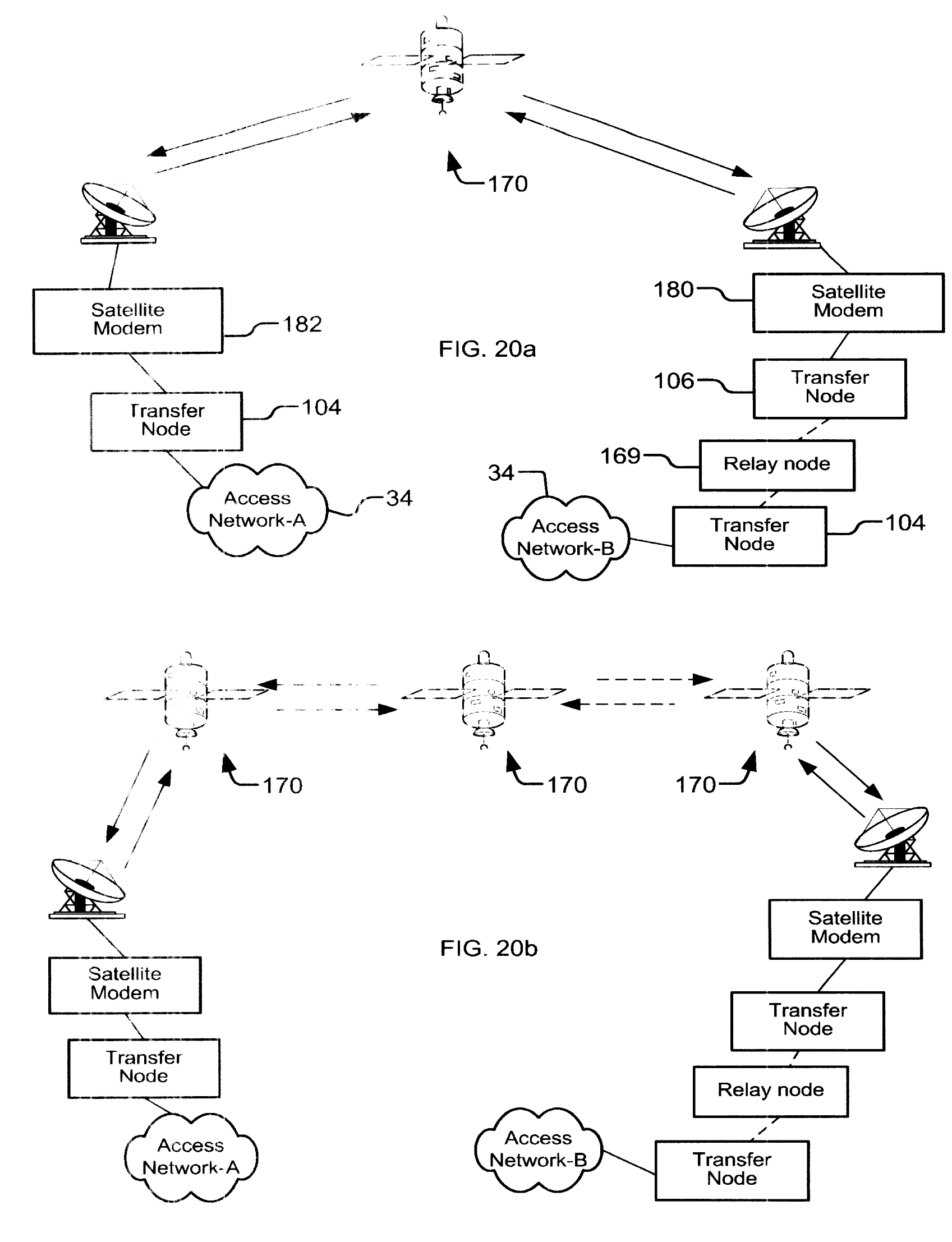

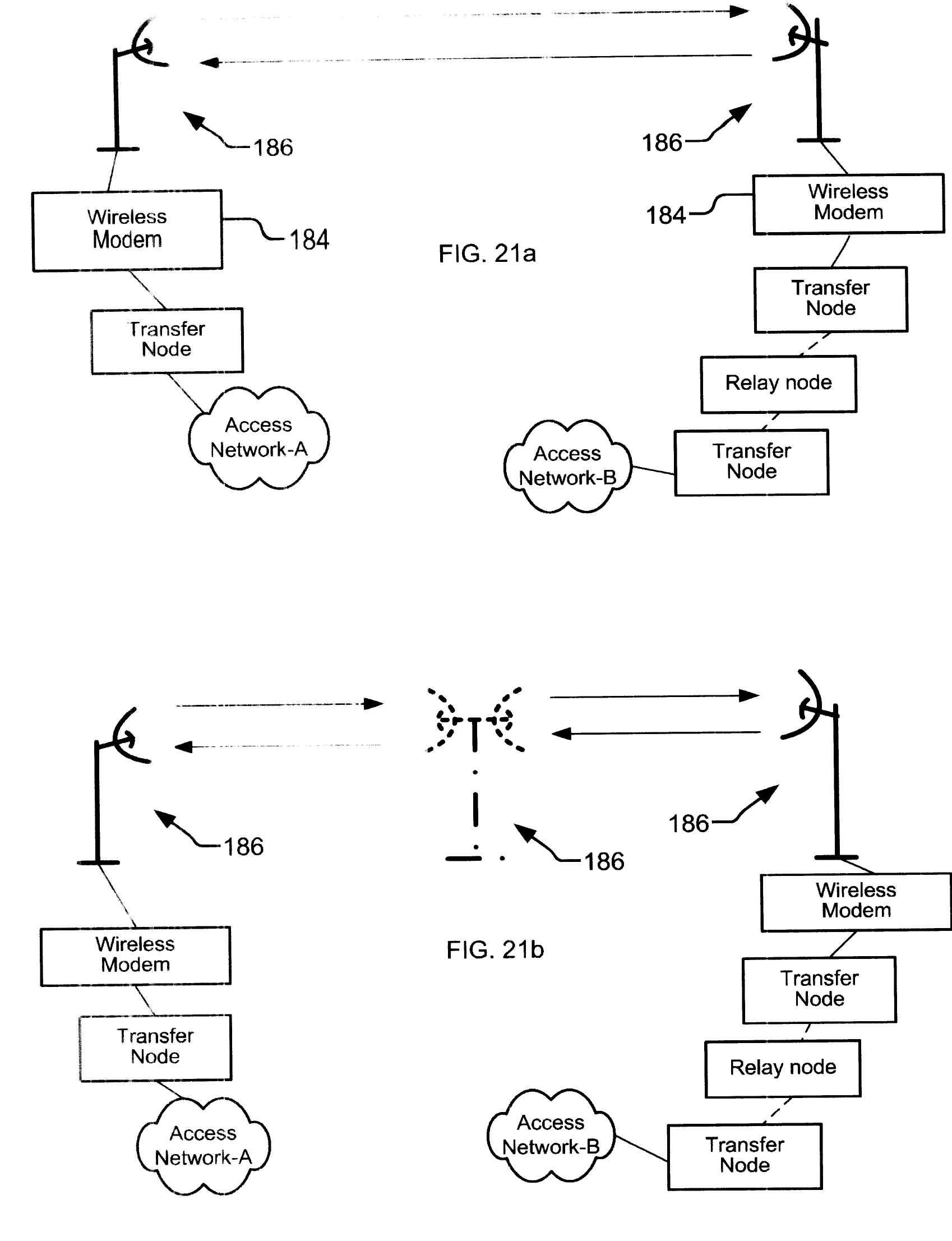

FIGS. 20a-b and 21a-c are schematic diagrams stylistically depicting applications of the BTSS 100 with wireless transmission links. FIG. 20a depicts connection of two access networks 34 via satellite modems 182 and a single satellite 170; whereas, FIG. 20b depicts connection of two access networks 34 via multiple satellites 170. FIG. 21 a depicts connection of two access networks 34 via respective dish modems 184 and ground stations 186 (line-of-sight wireless or media-less optical); whereas, FIG. 21b depicts connection of two access networks 34 via multiple ground stations 186, including one that is a repeater station between two access stations serving respective the access networks 34; and FIG. 21c depicts connection of two access networks 34 via respective wireless modems 188 and antennas 190.

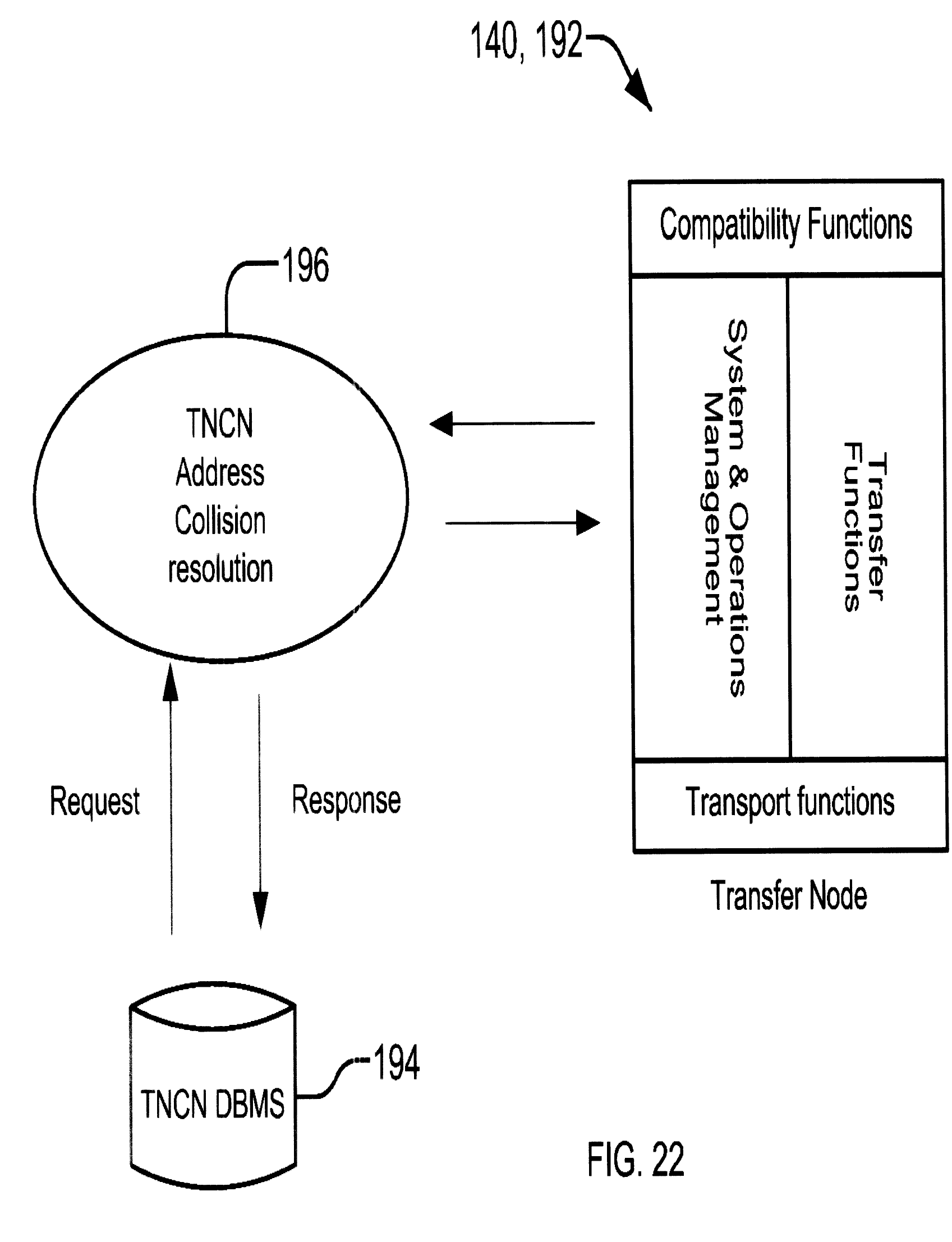

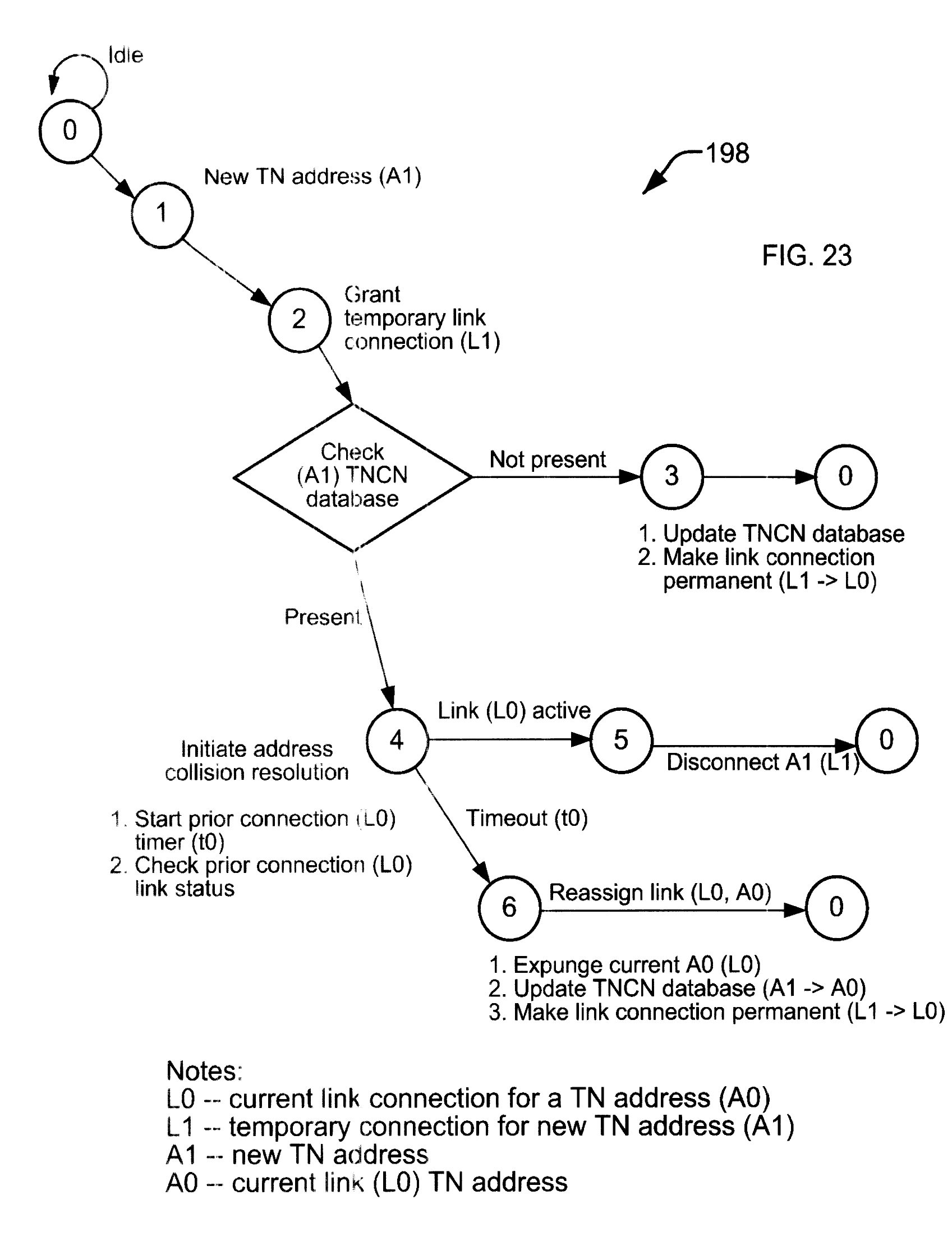

FIG. 22 is a schematic block diagram depicting an enhanced central node 192 suitable for resolving address collisions. In addition to the elements of the previously discussed central node (transfer switch 108), the enhanced central node 192 has a database 194 that can be used to store information about the state of the transfer network nodes, links, and connected devices, including active MAC addresses and the links and access networks 34 on which they are active. With suitable software 196 to access the database 194, the enhanced central node 192 provides a way to interconnect sub networks sub-networks (access networks 34, network-A, network-B, etc.) without an existing network infrastructure, such as that provided by full-featured embodiments of the BTSS 100 (see e.g., FIG. 4 including an IP network 18, a SS7 network 20, POTS lines 24, and a broadband network 36).

FIG. 23 is a state diagram depicting a suitable address collision resolution system 198, wherein the connected devices can move between different transmission links. As noted above, the enhanced central node 192 has a database 194 to keep track of the device addresses connected to the transmission links. Address collisions can then be avoided using the collision resolution system 198 in the following manner. If a device address is not present in the database 194, the device is accepted into the BTSS 100. If the device address is already in the database 194, preference is given to an existing connection and access of the new device to the BTSS 100 is denied. The presence of an existing device for the address is accomplished with a device status request, and a time-out mechanism. The presence of an existing device is detected by an affirmative status message. Lack of an affirmative status message and/or response time-out is used as an indication that the device with the address is absent or inactive in the BTSS 100. In which case, the new device is granted access into the BTSS 100. And the device information stored in the database 194. Spoof detection and prevention steps are not implemented as part of the media access part of the BTSS 100, but may be implemented as a higher layer or implemented as native to the network device.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

### INDUSTRIAL APPLICABILITY

The bandwidth transfer switching system (BTSS 100) is well suited for application in upgrading the existing PSTN 14, as well as constructing private networks or connecting such to the existing PSTN 14. As modern communications evolves from analog based systems to digital ones it is increasingly necessary to provide the capability to handle both analog and digital data types, or as these are commonly known, switched circuit and data packet communications traffic. While the eventual goal, arguably, is to arrive at an Internet protocol based system wherein only data packet is used, switching the existing PSTN 14 to an Internet protocol network (IP network 18) is simply not realistic. A transitional approach of constructing the IP network 18 in parallel with the existing PSTN 14 is also not practical. This has resulted in a piecemeal hybridizing approach wherein both switched circuit and data packet traffic are forced through at least part of the existing PSTNs 14, with the result that some segments of it are severely burdened.

The BTSS 100 permits an incremental approach to the problems of upgrading our communications infrastructure by providing access networks 34 to the customer premises 42 and then separating the traffic types early in the telco central office 56 or even in the remote concentrators 106 (i.e., the distributor nodes). It permits continued usage of the considerable existing investment in copper wire lines 166, and their gradual replacement with fiber optic lines 168 in key, high traffic volume, segments of the communications system.

In this manner, the BTSS 100 is able to effectively and economically integrate communications between telephones 12a, facsimiles 12b, modems 12c, computers 12d, special services devices 12e (e.g., alarm and utility metering systems), digital voice phones 12f, video units 12g, LANs 44, and WANs 64 (including the Internet). Furthermore, while doing this the BTSS 100 is also able to help in reducing peripheral communications problems like the current IP address shortage, network security and privacy, unifying directory services, and providing additional number services in our finite numbering schemes.

For the above, and other, reasons, it is expected that the BTSS 100 of the present invention will have widespread industrial applicability. Therefore, it is expected that the commercial utility of the present invention will be extensive and long lasting.

1. An improved communications system of the type in which a public switched telephone network has communications devices of both circuit switched and packet transfer types at a plurality of customer premises that intercommunicate via at least one telco central office with communications devices of like respective types, the improvement comprising:
an access network including an access concentrator located at a first said customer premises and a transfer switch located at a first said telco central office;
wherein said access concentrator:
accepts both switched signals from said circuit switched types of said communications devices and packet signals from said packet transfer types of said communications devices; and
communicates both of said switched signals and said packet signals as a terminating node signal to said transfer switch; and wherein said transfer switch:
accepts said terminating node signal from said access concentrator;
separates said switched signals from said terminating node signal for transmission onward to instances of said circuit switched types of said communications devices at another said customer premises than said first said customer premises; and
separates said packet signals from said terminating node signal for routing onward to instances of said packet transfer types of said communications devices at another said customer premises than said first said customer premises.

2. The improved communications system of claim 1, further comprising at least one relay node located between said access concentrator and said transfer switch, to communicate said terminating node signal over longer distances between the customer premises and the telco central office.

3. The improved communications system of claim 1, wherein:
said terminating node signal includes a circuit layer for said switched signals and at least one packet layer for said packet signal, wherein:
said circuit layer is configured as dedicated to a set number of sub-circuits when said access network is initially provisioned and thereby able to accommodate a like said number of said switched signals; and
said packet layers dynamically shared and thereby able to include a quantity of said packet signals ranging from as few as none to as many as a plurality.

4. The improved communications system of claim 1, wherein said access concentrator employs a protocol which is a member of the set consisting of POTS, T1, E1, DSx, xDSL, SLC-96, GR-303, and SONET/SDH.

5. The improved communications system of claim 1, wherein said access concentrator communicates said terminating node signal to said transfer switch step using a wireless link.

6. The improved communications system of claim 1, wherein:
the telco central office includes a central office switch connecting to said instances of said circuit switched types of said communications devices at said another said customer premises than said first said customer premises;
the telco central office includes a router connected to a digital network connecting to said instances of said packet transfer types of said communications devices at said another said customer premises than said first said customer premises; and
said transfer switch includes:
a first external interface connected to the central office switch, wherein said first external interface employs a protocol which is a member of the set consisting of T1, E1, and DSx to direct said switched signals into the central office switch; and
a second external interface connected to the digital network, wherein said second external interface employs a digital network protocol.

7. The improved communications system of claim 6, wherein said digital network protocol is a member of the set consisting of Ethernet, wireless LAN, universal serial bus (USB), firewire, infiniband, fiber-channel, bluetooth, and RFid.

8. The improved communications system of claim 1, wherein said access concentrator employs network address translation (NAT) along with private (non-routable, internal) internet protocol (IP) addresses.

9. The improved communications system of claim 1, wherein said transfer switch employs network address translation (NAT) along with private (non-routable, internal) internet protocol (IP) addresses.

10. The improved communications system of claim 1, wherein:
said packet transfer types of said communications devices employ ethernet signal protocols;
said access concentrator includes at least one ethernet interface, to send and receive said packet signals to and from said packet transfer types of said communications devices; and
said access concentrator is suitable for monitoring traffic on said access network, filtering it based on ethernet MAC addresses, transferring appropriate said traffic onward to said transfer switch in said terminating node signal.

11. The improved communications system of claim 10, further comprising at least one remote concentrator located between said access concentrator and said transfer switch, to communicate said terminating node signal over longer distances between the customer premises and the telco central office.

12. A method for bandwidth transfer on a public telecommunications network wherein communications devices using switched signals and packet signals are located at a plurality of customer premises and intercommunicate via at least one telco central office, the method comprising the steps of:
(1) accepting at least one customer signal from the communications devices into an access concentrator, wherein each said customer signal is a member of the set consisting of the switched signals and the packet signals;
(2) integrating all said customer signals received at said access concentrator into a terminating node signal;
(3) communicating said terminating node signal to a transfer switch;
(4) accepting at least one said terminating node signal at said transfer switch;
(5) separating all said switched signals from said terminating node signal and transmitting said switched signals onward to instances of said circuit switched types of said communications devices at another said customer premises than said first said customer premises; and
(6) separating all said packet signals from said terminating node and routing said packet signals onward to instances of said packet transfer types of said communications devices at another said customer premises than said first said customer premises.

13. The method of claim 12, further comprising passing said terminating node signal via at least one relay node located between said access concentrator and said transfer switch, to communicate said terminating node signal over longer distances between the customer premises and the telco central office.

14. The method of claim 12, wherein:
said terminating node signal includes a circuit layer for said switched signals and at least one packet layer for said packet signal, wherein:
said circuit layer is configured as dedicated to a set number of sub-circuits when said access network is initially provisioned and thereby able to accommodate a like said number of said switched signals; and
said packet layers dynamically shared and thereby able to include a quantity of said packet signals ranging from as few as none to as many as a plurality.

15. The method of claim 12, wherein said step (3) includes employing a protocol which is a member of the set consisting of POTS, T1, E1, DSx, xDSL, SLC-96, GR-303, and SONET/SDH.

16. The method of claim 12, wherein said step (3) includes wireless communication of said terminating node signal to said transfer switch.

17. The method of claim 12, wherein:
the telco central office includes a central office switch connected to said instances of said circuit switched types of said communications devices at said another said customer premises than said first said customer premises;
the telco central office includes a router connected to said instances of said packet transfer types of said communications devices at said another said customer premises than said first said customer premises;
said step (5) includes transmitting said switched signals via said central office switch; and
said step (6) includes routing said packet signals via said router.

18. The method of claim 17, wherein said step (6) further includes employing a digital network protocol which is a member of the set consisting of ethernet, wireless LAN, universal serial bus (USB), firewire, infiniband, fiber-channel, bluetooth, and RFid when routing said packet signals via said router.

19. The method of claim 12, wherein said step (1) includes network address translation (NAT) in said access concentrator.

20. The method of claim 12, wherein said step (3) includes network address translation (NAT) in said transfer switch.

21. The method of claim 12, wherein:
said customer signal is an instance of the packet signals; and
said step (1) includes receiving said customer signal into an ethernet interface; and
said step (2) includes filtering said customer signal for selective inclusion in said terminating node signal based on ethernet MAC addresses.

22. The method of claim 21, wherein said step (3) includes:
accepting at least one said terminating node signal into a remote concentrator;
integrating all said terminating node signals received at said remote concentrator into a distributor node signal; and
communicating said distributor node signal to a transfer switch in place of the original said terminating node signals.

23. The method of claim 22, wherein said step (3) includes wireless communication of said distributor node signal to said transfer switch.

24. An improved transfer switch for use via at least one telco central office in a communications system of the type in which a public switched telephone network has communications devices of both circuit switched and packet transfer types at a plurality of customer premises that intercommunicate, the improvement comprising:
said transfer switch accepting a terminating node signal from an access concentrator at a first said customer premises, wherein said access concentrator has formed said terminating node signal from both switched signals from said circuit switched types of said communications devices and packet signals from said packet transfer types of said communications devices;
said transfer switch separating said switched signals from said terminating node signal for transmission onward to instances of said circuit switched types of said communications devices at a second said customer premises; and
said transfer switch separating said packet signals from said terminating node signal for routing onward to instances of said packet transfer types of said communications devices at said second customer premises.

25. An improved access concentrator for use in a communications system of the type in which a public switched telephone network has communications devices of both circuit switched and packet transfer types at a plurality of customer premises that intercommunicate, the improvement comprising:
said access concentrator accepts both switched signals from said circuit switched types of said communications devices and packet signals from said packet transfer types of said communications devices; and
said access concentrator communicates both of said switched signals and said packet signals as a terminating node signal over a first internal interface to a transfer switch located at a said telco central office.
